(19) United States
(12) Patent Application Publication
(10) Pub. No.: US 2025/0330902 A1
(43) Pub. Date: Oct. 23, 2025

(54) EARLY DETECTION OF AVAILABLE STORAGE CAPACITY FOR COLLABORATIVE UPLOAD

(71) Applicant: TOYOTA MOTOR ENGINEERING & MANUFACTURING NORTH AMERICA, INC., PLANO, TX (US)

(72) Inventors: CHUNGHAN LEE, Mountain View, CA (US); SEYHAN UCAR, Mountain View, CA (US); ONUR ALTINTAS, Mountain View, CA (US); KENTARO OGUCHI, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/643,952

(22) Filed: Apr. 23, 2024

(51) Int. Cl. H04W 48/20; H04B 17/318; H04W 4/40; H04W 64/00

(52) U.S. Cl. CPC H04W 48/20; H04B 17/328; H04W 4/40; H04W 64/006

(57) ABSTRACT

Systems and methods are provided for identifying a mobile access point (AP) with sufficient storage capacity. The systems and methods may receive information from a mobile AP. The systems and methods may determine, based on the information, available storage capacity of the mobile AP to receive sender data of a sender vehicle. In response to determining the available storage capacity of the mobile AP is an amount sufficient to receive the sender data, the systems and methods may evaluate the mobile AP against other available mobile APs with sufficient available storage capacity to receive the sender data of the sender vehicle. The systems and methods may select, based on the evaluation, a designated mobile AP from the mobile AP and the other available mobile APs to receive the sender data. The systems and methods may send the sender data of the sender vehicle to the designated mobile AP.

### TECHNICAL FIELD

The present disclosure relates generally to the field of data communication, and in particular, some implementations may relate to systems and methods for early detections of available storage capacity in vehicles for vehicle-to-vehicle (V2V) communications.

### DESCRIPTION OF RELATED ART

Vehicles may be used as a means of transportation for the public. Vehicles may include automobiles, trucks, motorcycles, bicycles, scooters, mopeds, recreational vehicles and other like on- or off-road vehicles. Vehicles may further include autonomous, semi-autonomous and manual vehicles. As useful as a vehicle is for the transportation of persons, vehicles are also useful in the collection, storage, and communication of data that is obtained from the environment (e.g., roads, buildings, vehicles, persons, animals, weather, traffic, and other objects and conditions related to the environment).

With vehicles being a primary source of transportation, the collection of data by a vehicle may be important in providing visibility in the features, conditions, changes, and other aspects of the environment. When a vehicle is in motion and collecting data, the vehicle may have a limited amount of data storage to retain such collected data. When the data storage of a vehicle is fully occupied with collected data, the vehicle will have to offload the collected data to a centralized database to free up its data storage to allow more data to be collected. Currently, vehicles may offload data from its data storage when such vehicles are directly connected to an external communication link with a centralized database. Such an external communication link may be located at a vehicle's home base (e.g., the home of the owner of the vehicle) or at a dealership or repair shop of the respective vehicle. However, this method of offloading data from a vehicle is inefficient and limits the amount of data a vehicle may collect, thus hindering the ability to consistently acquire up-to-date data on the environment.

### BRIEF SUMMARY OF THE DISCLOSURE

According to various applications of the disclosed technology, systems and methods for identifying a mobile access point (AP) with sufficient storage capacity are provided.

In accordance with some implementations, a method for identifying a mobile access point (AP) with sufficient storage capacity is provided. The method may include: receiving information from a mobile access point (AP); determining, based on the information, available storage capacity of the mobile AP to receive sender data of a sender vehicle; in response to determining the available storage capacity of the mobile AP is an amount sufficient to receive the sender data, evaluating the mobile AP against other available mobile APs with sufficient available storage capacity to receive the sender data of the sender vehicle; selecting, based on the evaluation, a designated mobile AP from the first mobile AP and the other available mobile APs with sufficient available storage capacity to receive the sender data; and sending the sender data of the sender vehicle to the designated mobile AP.

In some applications, the method may further include: prior to receiving information from the mobile AP, sending a signal for transmitting the sender data to the mobile AP.

In some applications, wherein the mobile AP is part of a vehicle.

In some applications, the information received from the mobile AP comprises data storage capacity, communication settings, identification information, and navigation information.

In some applications, wherein the mobile AP and the other available mobile APs with sufficient available storage capacity are within a threshold distance from the sender vehicle.

In some applications, wherein the evaluating the mobile AP against the other available mobile APs comprises: determining a first signal strength of the mobile AP, wherein the first signal strength is based on the communication settings and the navigation information of the mobile AP with respect to the sender vehicle; and comparing the first signal strength of the mobile AP with signal strengths of the other available mobile APs.

In some applications, wherein the navigation information comprises a current location, direction of movement, speed, travel duration, and destination of the mobile AP.

In some applications, wherein the designated mobile AP has a highest signal strength with the sender vehicle from the mobile AP and the other available mobile APs.

In some applications, wherein the designated mobile AP is chosen, in part, based on its trajectory as compared to a trajectory of the sender vehicle.

In some applications, wherein the designated mobile AP is chosen, in part, based on the designated mobile AP comprising an application ready to initiate data transfer.

In some applications, the method may further include: in response to determining the available storage capacity of the mobile AP is an amount insufficient to receive the sender data, storing the mobile AP on a list of unavailable mobile APs for a determined time period.

In some applications, the method may further include: while sending the sender data of the sender vehicle to the designated mobile AP, adjusting a speed and trajectory of the sender vehicle according to navigation information of the designated mobile AP.

In another aspect, a system for identifying a mobile access point (AP) with sufficient storage capacity is provided that may include one or more processors; and memory coupled to the one or more processors to store instructions, which when executed by the one or more processors, may cause the one or more processors to perform operations. The operations may include: receiving information from a mobile access point (AP); determining, based on the information, available storage capacity of the mobile AP to receive sender data of a sender vehicle; in response to determining the available storage capacity of the mobile AP is an amount sufficient to receive the sender data, evaluating the mobile AP against other available mobile APs with sufficient available storage capacity to receive the sender data of the sender vehicle; selecting, based on the evaluation, a designated mobile AP from the mobile AP and the other available mobile APs with sufficient available storage capacity to receive the sender data; and sending the sender data of the sender vehicle to the designated mobile AP.

In some applications, the system may further include operations comprising: prior to receiving information from the mobile AP, sending a signal for transmitting the sender data to the mobile AP.

In some applications, wherein the mobile AP is part of a vehicle.

In some applications, the information received from the mobile AP comprises data storage capacity, communication settings, identification information, and navigation information.

In some applications, wherein the mobile AP and the other available mobile APs with sufficient available storage capacity are within a threshold distance from the sender vehicle.

In some applications, wherein the evaluating the mobile AP against the other available mobile APs with sufficient available storage capacity comprises: determining a first signal strength of the mobile AP, wherein the first signal strength is based on the communication settings and the navigation information of the mobile AP with respect to the sender vehicle; and comparing the first signal strength of the mobile AP with signal strengths of the other available mobile APs.

In some applications, wherein the navigation information comprises a current location, direction of movement, speed, travel duration, and destination of the mobile AP.

In some applications, wherein the designated mobile AP has a highest signal strength with the sender vehicle from the mobile AP and the other available mobile APs.

In some applications, wherein the designated mobile AP is chosen, in part, based on its trajectory as compared to a trajectory of the sender vehicle.

In some applications, wherein the designated mobile AP is chosen, in part, based on the designated mobile AP comprising an application ready to initiate data transfer.

In some applications, the system may further include operations comprising: in response to determining the available storage capacity of the mobile AP is an amount insufficient to receive the sender data, storing the mobile AP on a list of unavailable mobile APs for a determined time period.

In some applications, the system may further include operations comprising: while sending the sender data of the sender vehicle to the designated mobile AP, adjusting a speed and trajectory of the sender vehicle according to navigation information of the designated mobile AP.

In another aspect, a non-transitory machine-readable medium is provided. The non-transitory computer-readable medium may include instructions that when executed by a processor may cause the processor to perform operations including: receiving information from a mobile access point (AP); determining, based on the information, available storage capacity of the mobile AP to receive sender data of a sender vehicle; in response to determining the available storage capacity of the mobile AP is an amount sufficient to receive the sender data, evaluating the mobile AP against other available mobile APs with sufficient available storage capacity to receive the sender data of the sender vehicle; selecting, based on the evaluation, a designated mobile AP from the first mobile AP and the other available mobile APs to receive the sender data; and sending the sender data of the sender vehicle to the designated mobile AP.

In some applications, the non-transitory machine-readable medium may further include operations comprising: prior to receiving information from the mobile AP, sending a signal for transmitting the sender data to the mobile AP.

In some applications, wherein the mobile AP is part of a vehicle.

In some applications, the information received from the mobile AP comprises data storage capacity, communication settings, identification information, and navigation information.

In some applications, wherein the mobile AP and the other available mobile APs with sufficient available storage capacity are within a threshold distance from the sender vehicle.

In some applications, wherein the evaluating the mobile AP against the other available mobile APs comprises: determining a first signal strength of the mobile AP, wherein the first signal strength is based on the communication settings and the navigation information of the mobile AP with respect to the sender vehicle; and comparing the first signal strength of the mobile AP with signal strengths of the other available mobile APs.

In some applications, wherein the navigation information comprises a current location, direction of movement, speed, travel duration, and destination of the mobile AP.

In some applications, wherein the designated mobile AP has a highest signal strength with the sender vehicle from the mobile AP and the other available mobile APs.

In some applications, wherein the designated mobile AP is chosen, in part, based on its trajectory as compared to a trajectory of the sender vehicle.

In some applications, wherein the designated mobile AP is chosen, in part, based on the designated mobile AP comprising an application ready to initiate data transfer.

In some applications, the non-transitory machine-readable medium may further include operations comprising: in response to determining the available storage capacity of the mobile AP is an amount insufficient to receive the sender data, storing the mobile AP on a list of unavailable mobile APs for a determined time period.

In some applications, the non-transitory machine-readable medium may further include operations comprising: while sending the sender data of the sender vehicle to the designated mobile AP, adjusting a speed and trajectory of the sender vehicle according to navigation information of the designated mobile AP.

Other features and aspects of the disclosed technology will become apparent from the following detailed description, taken in conjunction with the accompanying drawings, which illustrate, by way of example, the features in accordance with applications of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various applications, is described in detail with reference to the following figures. The figures are provided for purposes of illustration only and merely depict typical or example applications.

FIG. 1 is an illustration of an example computing system for identifying a mobile access point (AP) with sufficient storage capacity, according to example applications described in the present disclosure.

FIG. 2 is an illustration of an example vehicle with which applications of the disclosed technology may be implemented.

FIG. 3 is an illustration of an example system for identifying a mobile access point (AP) with sufficient storage capacity, according to example applications described in the present disclosure.

FIG. 4 is an illustration of an example network of vehicles, according to example applications described in the present disclosure.

FIG. 5 is an illustration of example communication connections between vehicles, according to example applications described in the present disclosure.

FIG. 6 is an illustration of an example flowchart for identifying a mobile access point (AP) with sufficient storage capacity, according to one example application described in the present disclosure.

FIG. 7 is an illustration of an example flowchart for identifying a mobile access point (AP) with sufficient storage capacity, according to one example application described in the present disclosure.

FIG. 8 is an illustration of an example flowchart for identifying a mobile access point (AP) with sufficient storage capacity, according to one example application described in the present disclosure.

FIG. 9 is an illustration of an example computing component that includes one or more hardware processors and machine-readable storage media storing a set of machine-readable/machine-executable instructions that, when executed, cause the one or more hardware processors to perform an illustrative method for identifying a mobile access point (AP) with sufficient storage capacity, according to example applications described in the present disclosure.

FIG. 10 is an illustration of an example computing component that may be used to implement various features of applications described in the present disclosure.

The figures are not exhaustive and do not limit the present disclosure to the precise form disclosed.

### DETAILED DESCRIPTION

As described above, vehicles may be used as a means of transportation. As useful as a vehicle is for the transportation of persons, vehicles are also useful in the collection of data relating to features, conditions, changes, and other aspects of the environment. While a vehicle is in motion and collecting data of the environment, the vehicle may have a limitation on the amount of data it may collect because of its limited data storage capacity. When the data storage of a vehicle is fully occupied with collected data, the vehicle may have to offload its collected data to a centralized database or other location to free up its data storage and allow additional data to be collected and stored. Currently, vehicles are limited in methods of offloading data from its data storage, which includes being directly connected to an external communication link with a centralized database. Such an external communication link may be located at a vehicle's home base (e.g., the home of the owner of the vehicle) or at a dealership or repair shop of the respective vehicle. However, this method of offloading data from a vehicle is inefficient and limits the amount of data a vehicle may collect during its travels, thus hindering the ability to consistently acquire up-to-date data on the environment. This defect may further lead individuals to acquire inaccurate and incomplete environmental data, such as traffic data, road data, and landscape data, to adequately and efficiently navigate to their destinations.

Aspects of the technology disclosed herein may provide systems and methods configured to identify a mobile access point (AP) with sufficient data storage capacity to receive data of an ego vehicle. An ego vehicle may be a vehicle, such as an automobile, truck, motorcycle, bicycle, scooter, moped, recreational vehicle and other like on- or off-road vehicles. The ego vehicle may include, for example, an autonomous, semi-autonomous and manual operation. The ego vehicle may include one or more sensors that may be used to collect data, including, but not limited to, environmental data. The sensors may include, for example, a camera, image sensor, radar sensor, environmental sensor, | and ranging (LiDAR) sensor, electromyography sensor, motion sensor, pressure sensor, position sensor, audio sensor, infrared sensor, microwave sensor, optical sensor, haptic sensor, magnetometer, communication system and global positioning system (GPS). Data may be received by at least one sensor of the ego vehicle.

A mobile AP may be a vehicle, computer, smartphone, or any mobile device that may be transported and includes wireless broadband coverage/communications to receive data from other vehicles and transmit data to an external data storage system or centralized database, such as, for example, a cloud database system. The ego vehicle and mobile AP may each include a (wireless or wired) communication system to communicate with each other, other vehicles, infrastructure elements, cloud components and other external entities using any of a number of communication protocols including, for example, V2V (vehicle-to-vehicle), V2I (vehicle-to-infrastructure) and V2X (vehicle-to-everything) protocols. Such a wireless communication system may allow the ego vehicle and mobile AP to receive information from other objects and vehicles including, for example, data storage capacity information, communication signal information, map data, data regarding infrastructure elements, navigation data, data regarding operation and intention of surrounding vehicles, and so on. A wireless communication system may allow the ego vehicle and mobile AP to receive updates to data that can be used to execute one or more vehicle control modes, and vehicle control algorithms. Wireless communication system may also allow the ego vehicle and mobile AP to transmit information to other objects and receive information from other objects (such as other vehicles, user devices, or infrastructure).

The ego vehicle may be a vehicle that may include wireless broadband coverage/communications to receive data from and transmit data to a mobile AP. The ego vehicle may establish a communication link with a mobile AP. The ego vehicle may transmit data to the mobile AP using a communication connection. The mobile AP may receive and store the data retrieved from the ego vehicles if the mobile AP has sufficient data storage capacity. By transmitting data to the mobile AP, the ego vehicles may free up its data storage capacity to enable the collection and storage of additional data. The mobile AP may have a larger data storage capacity than the ego vehicle.

A mobile AP may be able to establish a communication link with a base station. A base station may be a tall, high-powered base station/cell tower that is able to maintain network signal strength across long/large distances. The mobile AP may connect with a base station when the mobile AP is located at a position that allows the mobile AP to communicate with the base station. Such locations where the mobile AP may communicate with a base station may include charging stations, workplaces, or a home base, where the mobile AP may have a strong enough signal strength to communicate with a base station.

Once the mobile AP is located at a position where a communication connection is established between the mobile AP and a base station, data retained by the mobile AP may be transferred to an external data storage system or centralized database, such as a cloud database system, using the base station. Transferring data from a mobile AP to an external data storage system may free up the data storage capacity of the mobile AP. This may allow the mobile AP to receive additional data from other vehicles, thus continuing to free up the individual data storage capacity of vehicles collecting environmental data, such as sender vehicles. As such, sender vehicles may efficiently and consistently collect data with minimum to no interferences caused by a lack of data storage capacity.

For an ego vehicle to transmit its data to a mobile AP, the ego vehicle may first send out a signal to all mobile APs surrounding the ego vehicle. The signal may include information indicating that the ego vehicle has data to transmit and offload from its data storage. The ego vehicle may receive information from any number of mobile APs that are surrounding the ego vehicle. The ego vehicle may receive information from a mobile AP when the mobile AP is within a perimeter or distance from the ego vehicle. The perimeter or distance from the ego vehicle that a mobile AP may be within may be preset or adjusted according to one or more contributing factors, including the time of day, infrastructure of the ego vehicle, communication settings of the sender vehicle, navigation trajectory of the ego vehicle, etc. The information of the mobile AP may include metadata on the mobile AP's data storage capacity, including the total data storage capacity, the amount of available data storage capacity, the amount of data storage capacity reserved for incoming data, etc. The metadata on the mobile AP may also include attributes and components of the mobile AP, including, for example, communication settings, identification information, navigation information, operating systems, and resources (e.g., CPU, memory, networking, applications, etc.). In this way, the ego vehicle may determine whether the mobile AP has a sufficient amount of available data storage capacity to receive and retain the data to be transmitted from the ego vehicle.

If the ego vehicle determines that the mobile AP does not have a sufficient amount of available data storage capacity to receive and retain the data to be transmitted, the ego vehicle may reject the establishment of a communication link with the mobile AP. If a communication link is already established between the ego vehicle and the mobile AP, then the ego vehicle may disconnect the communication link with the mobile AP upon a determination that the mobile AP has an insufficient amount of available data storage capacity to receive and retain the data of the ego vehicle to be transmitted. An ego vehicle may place any mobile AP that is determined to have insufficient data storage capacity on a list, such as a blacklist, of unavailable mobile APs for the ego vehicle. Mobile APs may remain on a list of unavailable of mobile APs for a particular period of time to allow the mobile APs to free up their data storage capacity. The particular period of time may be preset or adjusted based on one or more contributing factors, including the time of day, infrastructure of the ego vehicle, communication settings of the ego vehicle, navigation trajectory of the ego vehicle, etc. Each ego vehicle may have its own list, such as a blacklist, of unavailable mobile APs with insufficient data storage capacity. All mobile APs listed in a blacklist of an ego vehicle may be removed from the blacklist when the ego vehicle transmits its data to a mobile AP and frees up available space in its data storage.

Alternatively, if the ego vehicle determines that the mobile AP does have a sufficient amount of available data storage capacity to receive and retain the data to be transmitted, the ego vehicle may establish a communication link with the mobile AP. The ego vehicle may determine that a plurality of mobile APs each have a sufficient amount of available data storage capacity to receive and retain the data to be transmitted. When more than one mobile AP is determined to have a sufficient amount of available data storage capacity to receive and retain the ego vehicle's data, the ego vehicle may evaluate each of the mobile APs to determine a designated mobile AP to establish a communication link with.

Evaluating a plurality of mobile APs, each with a sufficient amount of available data storage capacity, may include determining and comparing the communication signal strength of each mobile AP with respect to the ego vehicle. The communication signal strength of a mobile AP may be based on the communication settings and navigation information of the respective mobile AP with respect to the ego vehicle. The communication settings may include the communication interface, protocols, components, and other communication capabilities and features of the mobile AP. The navigation information may include a current location, direction of movement, speed, travel duration, destination, and trajectory of the mobile AP. The communication signal strength of a mobile AP may further be based on whether the mobile AP includes an application for transferring data between vehicles. Such an application may include components and interfaces that may increase the speed, efficiency, and strength in establishing and maintaining a communication link between a mobile AP and an ego vehicle, and with transmitting data between the ego vehicle and the mobile AP.

Upon evaluating each of the plurality of mobile APs with sufficient available data storage capacity, the ego vehicle may select a mobile AP with the strongest communication signal strength to establish a communication link with. In this way, the ego vehicle may increase its likelihood in successfully transferring its data to the mobile AP with little to no interferences due to poor connections. To contribute to maintaining or increasing the signal strength and overall communication link between the ego vehicle and the mobile AP while the ego vehicle is transmitting its data to the mobile AP, the ego vehicle may adjust its navigational settings, including its speed and trajectory, to the navigational settings of the mobile AP. The ego vehicle may obtain the navigational settings of the mobile AP from the information received from the mobile AP.

Upon evaluating each of the plurality of mobile APs with sufficient available data storage capacity, the ego vehicle may select a mobile AP with an application for data transfer, such as, for example, a data sending application, a Wi-Fi setup application, a wireless connection application, etc. The ego vehicle may select a mobile AP with an application for data transfer that is active and available to support data to be transmitted between the ego vehicle and the mobile AP. Upon a determination that a mobile AP does not include an application for data transfer or a mobile AP does include an application for data transfer that is inactive and unavailable to support transmitting data, the ego vehicle may reject the establishment of a communication link with the mobile AP. If a communication link is already established between the ego vehicle and the mobile AP, then the ego vehicle may disconnect the communication link with the mobile AP upon a determination that the mobile AP does not include an application for data transfer or the mobile AP does include an application for data transfer that is inactive and unavailable to support transmitting data.

An ego vehicle may place any mobile AP that is determined to either not include an application for data transfer or include an application for data transfer that is inactive and unavailable to support transmitting data on a list, such as a blacklist, of unavailable mobile APs for the ego vehicle. Mobile APs may remain on a list of unavailable of mobile APs for a particular period of time to allow the mobile APs to obtain an active and available application for data transfer. The particular period of time may be preset or adjusted based on one or more contributing factors, including the time of day, infrastructure of the ego vehicle, communication settings of the ego vehicle, navigation trajectory of the ego vehicle, etc. Each ego vehicle may have its own list, such as a blacklist, of unavailable mobile APs. All mobile APs listed in a blacklist of an ego vehicle may be removed from the blacklist when the ego vehicle transmits its data to a mobile AP.

Once a communication link is established between the ego vehicle and the mobile AP, the ego vehicle may transmit its data to the mobile AP. When the mobile AP has received all of the transmitted data from the ego vehicle, the communication link between the ego vehicle and the mobile AP may be disconnected. The mobile AP and the ego vehicle may each continue traveling to their respective destinations. The ego vehicle may continue to collect, obtain and store data and may determine a next mobile AP to establish a communication link with and transmit data to when the ego vehicle's data storage capacity reaches a certain threshold. The threshold may be preset or adjusted according to one or more contributing factors, including the infrastructure of the vehicle. The mobile AP may establish connections with, and receive and retain additional data from other ego vehicles during the course of its travels. The mobile AP may obtain additional data until its data storage capacity reaches its limit, or until it reaches a location where it may connect to a base station to transmit all of the data to an external data storage system, such as a cloud database. Once the mobile AP has offloaded and transmitted its data to an external data storage system, the mobile AP may continue to establish connections with, and receive and retain additional data from other ego vehicles.

The present disclosure allows an ego vehicle to offload its data in various settings, freeing up the ego vehicle's data storage to permit the ego vehicle to efficiently and consistently collect data with minimum to no interferences caused by poor reception, bad communication connectivity, increased latency, and noise disturbances.

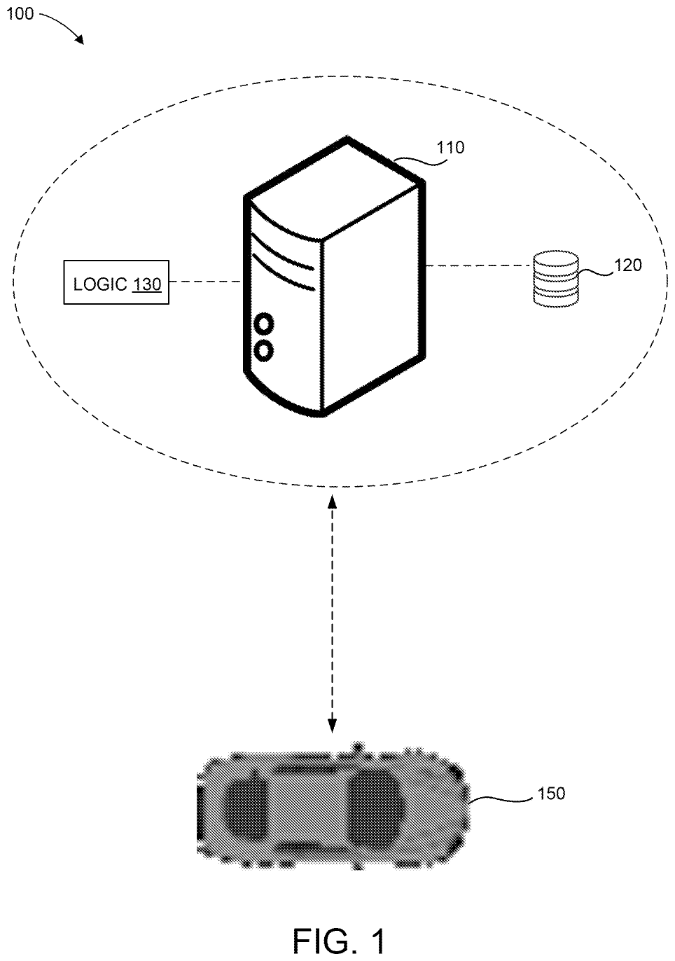

FIG. 1 illustrates an example of a computing system 100 which may be internal or otherwise associated within a vehicle 150. In some applications, the computing system 100 may be a machine learning (ML) pipeline and model, and use ML algorithms. In some examples, the vehicle 150 may be a vehicle, such as an automobile, truck, motorcycle, bicycle, scooter, moped, recreational vehicle and other like on- or off-road vehicles. The vehicle 150 may input data into computing component 110. The computing component 110 may perform one or more available operations on the input data to generate outputs, such as receive information from a mobile access point (AP) of a plurality of mobile APs, determine available data storage capacity of the mobile AP to receive sender data of the vehicle 150, in response to determining the available data storage capacity of the mobile AP is an amount sufficient to receive the sender data, evaluate the mobile AP amongst a plurality of available mobile APs with sufficient available data storage capacity to receive the sender data of the vehicle 150, select a designated mobile AP to receive the sender data of the vehicle 150, and send the sender data of the vehicle 150 to the designated mobile AP. A mobile AP may be a vehicle, computer, smartphone, or any mobile device that may be transported and includes wireless broadband coverage/communications to receive and transfer data to an external data storage system or centralized database, such as, for example, a cloud database system. The vehicle 150 may further display the outputs on a Graphical User Interface (GUI). The GUI may be in vehicle 150 or on a computing device, such as a desktop computer, a laptop, a mobile phone, a tablet device, an Internet of Things (IoT) device, etc. The GUI may display the outputs as a two-dimensional (2D) and three-dimensional (3D) layout and map showing the various outputs generated by algorithms, such as ML algorithms, based on various input data, such as connection links and data storage capacity of each of the vehicle 150 and a plurality of mobile APs.

The computing system 110 in the illustrated example may include one or more processors and logic 130 that implements instructions to carry out the functions of the computing component 110, for example, receiving information from a mobile AP of a plurality of mobile APs, determining available data storage capacity of the mobile AP to receive sender data of the vehicle 150, in response to determining the available data storage capacity of the mobile AP is an amount sufficient to receive the sender data, evaluating the mobile AP amongst a plurality of available mobile APs with sufficient available data storage capacity to receive the sender data of the vehicle 150, selecting a designated mobile AP to receive the sender data of the vehicle 150, and sending the sender data of the vehicle 150 to the designated mobile AP. The computing component 110 may store, in a database 120, details regarding scenarios or conditions in which some algorithms, image datasets, and assessments are performed and used to determine available data storage capacity of a mobile AP, evaluate the mobile AP amongst a plurality of available mobile APs, and select a designated mobile AP. Some of the scenarios or conditions will be illustrated in the subsequent figures.

A processor may include one or more GPUs, CPUs, microprocessors or any other suitable processing system. Each of the one or more processors may include one or more single core or multicore processors. The one or more processors may execute instructions stored in a non-transitory computer readable medium. Logic 130 may contain instructions (e.g., program logic) executable by the one or more processors to execute various functions of computing component 110. Logic 130 may contain additional instructions as well, including instructions to transmit data to, receive data from, and interact with vehicle 150.

ML can refer to methods that, through the use of algorithms, are able to automatically extract intelligence or rules from training data sets and capture the same in informative models. In turn, those models are capable of making predictions based on patterns or inferences gleaned from subsequent data input into a trained model. According to implementations of the disclosed technology, the ML algorithm comprises, among other aspects, algorithms implementing a Gaussian process and the like. The ML algorithms disclosed herein may be supervised and/or unsupervised depending on the implementation. The ML algorithms may emulate the observed characteristics and components of vehicles, road, and drivers to better evaluate and communicate with a plurality of mobile APs in the environment around an ego vehicle to determine available data storage capacity of each of the plurality of mobile APs, evaluate a plurality of available mobile APs, and select a designated mobile AP to send data of the ego vehicle.

Although one example computing system 110 is illustrated in FIG. 1, in various applications multiple computing systems 110 can be included. Additionally, one or more systems and subsystems of computing system 100 can include its own dedicated or shared computing component 110, or a variant thereof. Accordingly, although computing system 100 is illustrated as a discrete computing system, this is for ease of illustration only, and computing system 100 can be distributed among various systems or components.

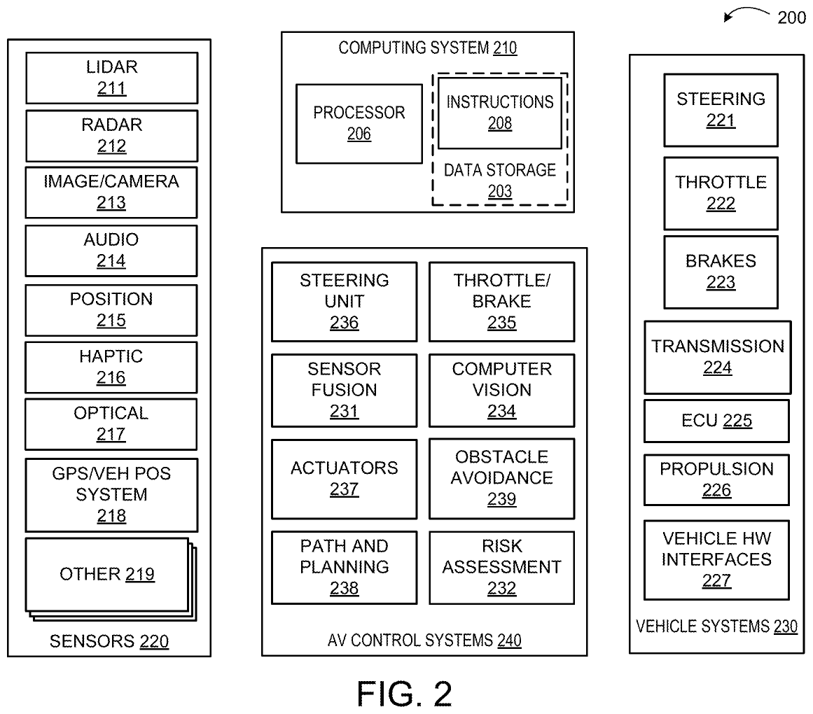

FIG. 2 is a schematic representation of various components or elements of an example connected vehicle 200, such as an autonomous, semi-autonomous or manual vehicle, with which applications of the disclosed technology may be implemented. As described herein, vehicle 200 can refer to a vehicle, such as an automobile, truck, motorcycle, bicycle, scooter, moped, recreational vehicle and other like on- or off-road vehicles, that may include an autonomous, semi-autonomous and manual operation. The vehicle 200 may include components, such as a computing system 210, sensors 220, AV control systems 240 and vehicle systems 230. Either of the computing system 210, sensors 220, AV control systems 240, and vehicle systems 230 can be part of an automated vehicle system/advanced driver assistance system (ADAS). ADAS can provide navigation control signals (i.e., control signals to actuate the vehicle and operate one or more vehicle systems 230 as shown in FIG. 2) for the vehicle to navigate a variety of situations. As used herein, ADAS can be an autonomous vehicle control system adapted for any level of vehicle control and driving autonomy. For example, the ADAS can be adapted for level 1, level 2, level 3, level 4, and level 5 autonomy (according to SAE standard). ADAS can allow for control mode blending (i.e., blending of autonomous and assisted control modes with human driver control). ADAS can correspond to a real-time machine perception system for vehicle actuation in a multi-vehicle environment. Vehicle 200 may include a greater or fewer quantity of systems and subsystems, and each could include multiple elements. Accordingly, one or more of the functions of the technology disclosed herein may be divided into additional functional or physical components, or combined into fewer functional or physical components. Additionally, although the systems and subsystems illustrated in FIG. 2 are shown as being partitioned in a particular way, the functions of vehicle 200 can be partitioned in other ways. For example, various vehicle systems and subsystems can be combined in different ways to share functionality.

Sensors 220 may include a plurality of different sensors to gather data regarding vehicle 200, its operator, its operation and its surrounding environment. Although various sensors are shown, it can be understood that systems and methods for detecting and responding to intervening obstacles may not require many sensors. It can also be understood that system and methods described herein can be augmented by sensors off the vehicle 200. In this example, sensors 220 include light detection and ranging (LIDAR) sensor 211, radar sensor 212, image sensors 213 (e.g., a camera), audio sensors 214, position sensor 215, haptic sensor 216, optical sensor 217, a Global Positioning System (GPS) or other vehicle positioning system 218, and other like distance measurement and environment sensing sensors 219. Sensors 220 may further include security sensors to monitory the security of the vehicle 200 when the vehicle is parked and stationary. One or more of the sensors 220 may gather data, such as environmental data (e.g., weather, roads, buildings, pedestrians, animals, vehicles, objects, traffic, landmarks, etc.) and vehicle data (e.g., physical structure, data storage capacity, communication settings, identification information, navigation information, etc.), and send that data to the vehicle electronic control unit (ECU) or other processing unit. Sensors 220 (and other vehicle components) may be duplicated for redundancy.

Distance measuring sensors such as LiDAR sensor 211, radar sensor 212, IR sensors and other like sensors can be used to gather data to measure distances and closing rates to various external objects such as other vehicles, roads, traffic signs, pedestrians, light poles and other objects. Image sensors 213 can include one or more cameras or other image sensors to capture images of the environment around the vehicle, such as weather and road surfaces, as well as internal to the vehicle. Information from image sensors 213 (e.g., camera) can be used to determine information about the environment surrounding the vehicle 200 including, for example, information regarding weather, road surfaces and other objects surrounding vehicle 200. For example, image sensors 213 may be able to recognize specific vehicles (e.g., color, vehicle type), landmarks or other features (including, e.g., street signs, traffic lights, etc.), slope of the road, lines on the road, damages and other potentially hazardous conditions to the road, curbs, objects to be avoided (e.g., other vehicles, pedestrians, bicyclists, etc.) and other landmarks or features. Information from image sensors 213 can be used in conjunction with other information such as map data, or information from positioning system 218 to determine, refine, or verify vehicle (ego vehicle or another vehicle) location as well as detect obstructions.

Vehicle positioning system 218 (e.g., GPS or other positioning system) can be used to gather position information about a current location of the vehicle as well as other positioning or navigation information, such as the positioning information about a current location and direction of movement of the vehicle according to a particular road.

Other sensors 219 may be provided as well. Other sensors 219 can include vehicle acceleration sensors, vehicle speed sensors, wheelspin sensors (i.e., one for each wheel), tire pressure monitoring sensors (i.e., one for each tire), vehicle clearance sensors, left-right and front-rear slip ratio sensors, environmental sensors (i.e., to detect weather, traction conditions, or other environmental conditions), seat pressure monitoring sensors (i.e., in the driver seat to measure muscle tension of the driver), motion sensors, electromyography sensors, and microwave sensors. Other sensors 219 can be further included for a given implementation of ADAS. Various sensors 220, such as other sensors 219, may be used to provide input to computing system 210 and other systems of vehicle 200 so that the systems have information useful to determine a navigational trajectory of the vehicle 200 to determine a plurality of mobile APs around the vehicle 200, determine available data storage capacity and signal strength of each of the plurality of mobile APs, determine a plurality of available mobile APs that have an amount of data storage capacity sufficient to receive and hold data of the vehicle 200, and evaluate the plurality of available mobile APs to determine a designated mobile AP to receive the data of the vehicle 200.

AV control systems 240 may include a plurality of different systems/subsystems to control operation of vehicle 200. In this example, AV control systems 240 can include, autonomous driving module (not shown), steering unit 236, throttle and brake control unit 235, sensor fusion module 231, computer vision module 234, path and planning module 238, obstacle avoidance module 239, risk assessment module 232 and actuator(s) 237. Sensor fusion module 231 can be included to evaluate data from a plurality of sensors, including sensors 220. Sensor fusion module 231 may use computing system 210 or its own computing system to execute algorithms to assess inputs from the various sensors.

Throttle and brake control unit 235 can be used to control actuation of throttle and braking mechanisms of the vehicle to accelerate, slow down, stop or otherwise adjust the speed of the vehicle. For example, the throttle unit can control the operating speed of the engine or motor used to provide motive power for the vehicle. Likewise, the brake unit can be used to actuate brakes (e.g., disk, drum, etc.) or engage regenerative braking (i.e., such as in a hybrid or electric vehicle) to slow or stop the vehicle.

Steering unit 236 may include any of a number of different mechanisms to control or alter the heading of the vehicle. For example, steering unit 236 may include the appropriate control mechanisms to adjust the orientation of the front or rear wheels of the vehicle to accomplish changes in direction of the vehicle during operation. Electronic, hydraulic, mechanical or other steering mechanisms may be controlled by steering unit 236.

Computer vision module 234 may be included to process image data (e.g., image data captured from image sensors 213, or other image data) to evaluate the environment within or surrounding the vehicle. For example, algorithms operating as part of computer vision module 234 can evaluate still or moving images to determine features and landmarks (e.g., road pavements, lines of the road, damages and other potentially hazardous conditions on the road, road signs, traffic lights, lane markings and other road boundaries, etc.), obstacles (e.g., pedestrians, bicyclists, other vehicles, other obstructions in the path of the subject vehicle) and other objects. The system can include video tracking and other algorithms to recognize objects such as the foregoing, estimate their speed, map the surroundings, and so on. Computer vision module 234 may be able to model the road traffic vehicle network, predict incoming hazards and obstacles, predict road hazard, and determine one or more contributing factors to identifying obstructions. Computer vision module 234 may be able to perform depth estimation, image/video segmentation, camera localization, and object classification according to various classification techniques (including by applied neural networks).

Path and planning module 238 may be included to compute a desired path for vehicle 200 based on input from various other sensors and systems. For example, path and planning module 238 can use information from positioning system 218, sensor fusion module 231, computer vision module 234, obstacle avoidance module 239 (described below) and other systems (e.g., AV control systems 240, sensors 220, and vehicle systems 230) to determine a safe path to navigate the vehicle along a segment of a desired route. Path and planning module 238 may also be configured to dynamically update the vehicle path as real-time information is received from sensors 220 and other control systems 240.

Obstacle avoidance module 239 can be included to determine control inputs necessary to avoid obstacles and obstructions detected by sensors 220 or AV control systems 240. Obstacle avoidance module 239 can work in conjunction with path and planning module 238 to determine an appropriate path to avoid and navigate around obstacles and obstructions.

Path and planning module 238 (either alone or in conjunction with one or more other module of AV control systems 240, such as obstacle avoidance module 239, computer vision module 234, and sensor fusion module 231) may also be configured to perform and coordinate one or more vehicle maneuvers. Example vehicle maneuvers can include at least one of a path tracking, stabilization and collision avoidance maneuver. With connected vehicles, vehicle maneuvers can be performed at least partially cooperatively between the connected vehicles to gather a sufficient amount of data of the environment, including obstructions and traffic. A sufficient amount of data of an obstruction may include collecting data of the obstruction at various angles and perspectives. Each different type of obstruction may warrant a different amount of data to be collected and analyzed to make the needed determinations to verify the obstruction and determine the condition of traffic. For example, data needed to verify a small obstruction, like a small pothole, may be minimal as the connected vehicles collecting verification data of the small pothole obstruction may only need to collect data of missing asphalt on the road. The data needed to verify a larger obstruction, like a downed traffic light, may be much more extensive as the connected vehicles collecting verification data of the downed traffic light obstruction may need to collect data of the portion of the roadway blocked by the downed traffic light, electrical issues present on the roadway, disrupted traffic flow caused by the downed traffic light, including, for example, any other vehicles or objects blocking traffic due to the downed traffic light, additional obstructions on the road caused by the downed traffic light, including, for example, cracks, potholes, debris, etc., and so on. Hence, those of ordinary skill in the art will understand what sufficient means in the context of collecting a sufficient amount of data to verify an obstruction to determine the condition of traffic.

Vehicle systems 230 may include a plurality of different systems/subsystems to control operation of vehicle 200. In this example, vehicle systems 230 include steering system 221, throttle system 222, brakes 223, transmission 224, electronic control unit (ECU) 225, propulsion system 226 and vehicle hardware interfaces 227. The vehicle systems 230 may be controlled by AV control systems 240 in autonomous, semi-autonomous or manual mode of vehicle 200. For example, in autonomous or semi-autonomous mode, AV control systems 240, alone or in conjunction with other systems, can control vehicle systems 230 to operate the vehicle in a fully or semi-autonomous fashion. When control is assumed, computing system 210 and AV control system 230 can provide vehicle control systems to vehicle hardware interfaces for controlled systems such as steering angle 221, brakes 223, throttle 222, or other hardware interfaces 227, such as traction force, turn signals, horn, lights, etc. This may also include an assist mode in which the vehicle takes over partial control or activates ADAS controls (e.g., AC control systems 240) to assist the driver with vehicle operation.

Computing system 210 in the illustrated example includes a processor 206, and memory 203. Some or all of the functions of vehicle 200 may be controlled by computing system 210. Processor 206 can include one or more GPUs, CPUs, microprocessors or any other suitable processing system. Processor 206 may include one or more single core or multicore processors. Processor 206 executes instructions 208 stored in a non-transitory computer readable medium, such as memory 203.

Memory 203 may contain instructions (e.g., program logic) executable by processor 206 to execute various functions of vehicle 200, including those of vehicle systems and subsystems. Memory 203 may contain additional instructions as well, including instructions to transmit data to, receive data from, interact with, and control one or more of the sensors 220, AV control systems 240 and vehicle systems 230. In addition to the instructions, memory 203 may store data and other information used by the vehicle 200 and its systems and subsystems for operation, including operation of vehicle 200 in the autonomous, semi-autonomous or manual modes. For example, memory 203 can include data that has been communicated to an ego vehicle (e.g., via V2V (vehicle-to-vehicle) communication), mapping data, a model of the current or predicted road traffic vehicle network, vehicle dynamics data, computer vision recognition data, and other data which can be useful for the execution of one or more vehicle maneuvers, for example by one or more modules of the AV control systems 240.

Although one computing system 210 is illustrated in FIG. 2, in various applications multiple computing systems 210 can be included. Additionally, one or more systems and subsystems of vehicle 200 can include its own dedicated or shared computing system 210, or a variant thereof. Accordingly, although computing system 210 is illustrated as a discrete computing system, this is for ease of illustration only, and computing system 210 can be distributed among various vehicle systems or components.

Vehicle 200 may also include a (wireless or wired) communication system (not illustrated) to communicate with other vehicles, infrastructure elements, cloud components and other external entities using any of a number of communication protocols including, for example, V2V (vehicle-to-vehicle), V2I (vehicle-to-infrastructure) and V2X (vehicle-to-everything) protocols. Such a wireless communication system may allow vehicle 200 to receive information from other objects and vehicles including, for example, map data, data regarding infrastructure elements, data regarding operation and intention of surrounding vehicles, and so on. A wireless communication system may allow vehicle 200 to receive updates to data that can be used to execute one or more vehicle control modes, and vehicle control algorithms as discussed herein. Wireless communication system may also allow vehicle 200 to transmit information to other objects and receive information from other objects (such as other vehicles, user devices, or infrastructure). In some applications, one or more communication protocol or dictionaries can be used, such as the SAE J2935 V2X Communications Message Set Dictionary. In some applications, the communication system may be useful in retrieving and sending one or more data useful in identifying a mobile access point (AP) with sufficient data storage capacity, as disclosed herein. A mobile AP may be a vehicle, computer, smartphone, or any mobile device that may be transported and includes wireless broadband coverage/communications to receive and transfer data to an external data storage system or centralized database, such as, for example, a cloud database system.

Communication system can be configured to receive data and other information from sensors 220 that is used in determining whether and to what extent control mode blending should be activated. Additionally, communication system can be used to send an activation signal or other activation information to various vehicle systems 230 and AV control systems 240 as part of controlling the vehicle. For example, communication system can be used to send signals to one or more of the vehicle actuators 237 to control parameters, for example, maximum steering angle, throttle response, vehicle braking, torque vectoring, and so on.

In some applications, computing functions for various applications disclosed herein may be performed entirely on computing system 210, distributed among two or more computing systems 210 of vehicle 200, performed on a cloud-based platform, performed on an edge-based platform, or performed on a combination of the foregoing.

Path and planning module 238 can allow for executing one or more vehicle control mode(s), and vehicle control algorithms in accordance with various implementations of the systems and methods disclosed herein.

In operation, path and planning module 238 (e.g., by a driver intent estimation module, not shown) can receive information regarding human control input used to operate the vehicle. As described above, information from sensors 220, actuators 237 and other systems can be used to determine the type and level of human control input. Path and planning module 238 can use this information to predict driver action. Path and planning module 238 can use this information to generate a predicted path and model the road traffic vehicle network. This may be useful in evaluating road conditions, determining and verifying obstructions, and determining traffic conditions. As also described above, information from sensors, and other systems can be used to evaluate road conditions, determine and verify obstructions, and determine traffic conditions. Eye state tracking, attention tracking, or intoxication level tracking, for example, can be used to determine vehicle movement patterns according to inherent human behavior. It can be understood that the driver state, time, location of vehicle 200, navigation trajectory of vehicle 200, data collected and stored by vehicle 200, and communication system of the vehicle 200 can contribute to identify a mobile AP with sufficient data storage capacity as disclosed herein. Driver state can be provided to a risk assessment module 232 to determine the level of risk associated with a navigation trajectory of the vehicle 200. Although not illustrated in FIG. 2, where the assessed risk contributes to determining vehicle movement patterns according to inherent human behaviors, a verification strategy may be generated and provided to vehicle 200 to determine traffic conditions.

Path and planning module 238 can receive state information such as, for example from visibility maps, traffic and weather information, traffic information, hazard maps, and local map views. Information from a navigation system can also provide a mission plan including maps and routing to path and planning module 238.

The path and planning module 238 (e.g., by a driver intent estimation module, not shown) can receive this information and predict behavior characteristics within a future time horizon. This information can be used by path and planning module 238 for executing one or more planning decisions. Planning decisions can be based on one or more policy (such as defensive driving policy). Planning decisions can be based on one or more level of autonomy, connected vehicle actions, one or more policy (such as defensive driving policy, cooperative driving policy, such as swarm or platoon formation, leader following, etc.). Path and planning module 238 can generate an expected model for the road traffic hazards and assist in creating a predicted traffic hazard level and verification strategy for vehicles to implement. Path and planning module 238 can generate an expected model for the navigation trajectory and assist in creating a predicted navigation trajectory for vehicles to implement.

Path and planning module 238 can receive risk information from risk assessment module 232. Path and planning module 238 can receive vehicle capability and capacity information from one or more vehicle systems 230. Vehicle capability can be assessed, for example, by receiving information from vehicle hardware interfaces 229 to determine vehicle capabilities and identify a reachable set model. Path and planning module 238 can receive surrounding environment information (e.g., from computer vision module 234, and obstacle avoidance module 239). Path and planning module 238 can apply risk information and vehicle capability and capacity information to trajectory information (e.g., based on a planned trajectory and driver intent) to determine a safe or optimized trajectory for the vehicle given the drivers intent, policies (e.g., safety or vehicle cooperation policies), communicated information, given one or more obstacles in the surrounding environment, road conditions, traffic conditions, etc. Path and planning module 238 can receive traffic and navigation information (e.g., from computer vision module 234, and risk assessment module 232). This trajectory information can be provided to controller (e.g., ECU 225) to provide partial or full vehicle control in the event of a risk level above threshold. Path and planning module 238 can apply risk information and vehicle capability and capacity information to navigation trajectory information and communication information of the vehicle 200 to determine a safe or optimal navigation trajectory for the vehicle 200. Information from risk assessment module 232 can be used to generate countermeasures described herein. A signal from risk assessment module 232 can trigger ECU 225 or another AV control system 230 to take over partial or full control of the vehicle.

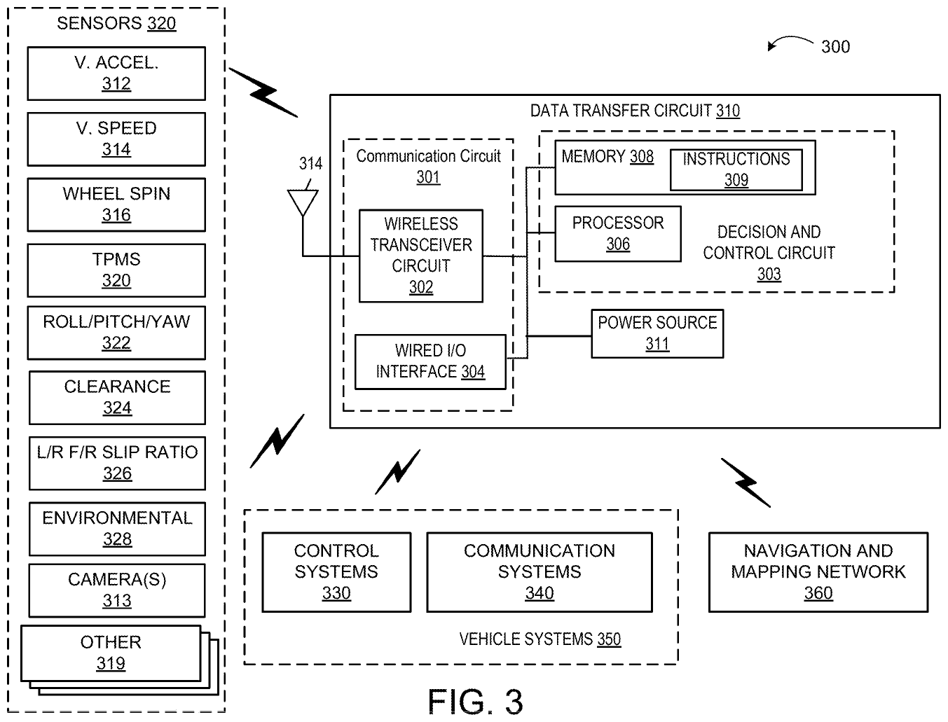

FIG. 3 illustrates an example architecture for identifying a mobile access point (AP) with sufficient data storage capacity for an ego vehicle described herein. Referring now to FIG. 3, in this example, a data transfer system 300 includes a data transfer circuit 310, a plurality of sensors 320, and a plurality of vehicle systems 350. Also included are various elements of navigation and mapping network 360 with which the data transfer system 300 can communicate. It can be understood that a navigation and mapping network 360 can include various elements that are important in a navigation and mapping network, such as vehicles, pedestrians (with or without connected devices that can include aspects of data transfer system 300 disclosed herein), or infrastructure (e.g., traffic signals, sensors, such as traffic cameras, databases, central servers, weather sensors). Other elements of the navigation and mapping network 360 can include connected elements at workplaces, charging stations, or the home (such as vehicle chargers, connected devices, appliances, etc.).

Data transfer system 300 can be implemented as and include one or more components of the vehicle 200 shown in FIG. 2. Sensors 320, vehicle systems 350, and elements of navigation and mapping network 360, can communicate with the data transfer circuit 310 via a wired or wireless communication interface. As previously alluded to, elements of navigation and mapping network 360 can correspond to connected or unconnected devices, infrastructure (e.g., traffic signals, sensors, such as traffic cameras, weather sensors), vehicles, pedestrians, objects, etc. that are in a broad or immediate vicinity of an ego-vehicle (e.g., vehicle 150, vehicle 200) or otherwise important to the vehicle security network (such as remote infrastructure). Although sensors 320, vehicle systems 350, and navigation and mapping network 360, are depicted as communicating with data transfer circuit 310, they can also communicate with each other, as well as with other vehicle systems 350 and directly with element of a navigation and mapping network 360.

Data as disclosed herein can be communicated to and from data transfer circuit 310. For example, various infrastructure (example element of navigation and mapping network 360) can include one or more databases, such as vehicle infrastructure data, road data, traffic data, environment data, obstacle data, construction data, mapping data, navigation data, etc. This data can be communicated to the circuit 310, and such data can be updated based on outcomes for one or more actions or changes to the navigation and mapping network, vehicle system, communication system, or data system from sensors 320 (e.g., navigation trajectory of surrounding vehicles) of the ego vehicle. All of this data can be included in and contribute to predictive analytics (e.g., by machine learning) of navigation trajectory, collection and storage of data, and communication capabilities of the ego vehicle and other surrounding vehicles. Similarly, models, circuits, and predictive analytics can be updated according to various outcomes.

Data transfer circuit 310 can evaluate data, such as metadata and other related information, received from a mobile access point (AP), actions made by the ego vehicle, and actions occurring to the ego vehicle to select a designated mobile AP with a sufficient amount of data storage capacity to receive data as described herein. A mobile AP may be a vehicle, computer, smartphone, or any mobile device that may be transported and includes wireless broadband coverage/communications to receive data from one or more vehicles and transfer data to an external data storage system or centralized database, such as, for example, a cloud database system. Data, such as metadata and other related information, received from a mobile AP may include attributes and components of the mobile AP, including, for example, data storage capacity, communication settings, identification information, navigation information, operating systems, and resources (e.g., CPU, memory, networking, applications, etc.). As will be described in more detail herein, the determination of available storage capacity, signal strength, and a designated mobile AP can have one or more contributing factors. Various sensors 320, vehicle systems 350, and navigation and mapping network 360 elements may contribute to gathering data for determining available data storage capacity and signal strength of a plurality of mobile APs, determining a plurality of available mobile APs that have an amount of data storage capacity sufficient to receive and hold data of an ego vehicle, and evaluating the plurality of available mobile APs to determine a designated mobile AP to receive the data of the ego vehicle. For example, the data transfer circuit 310 can include at least one of a decision and control circuit, such as decision and control circuit 303. The data transfer circuit 310 can be implemented as an ECU or as part of an ECU such as, for example electronic control unit 225. In other applications, data transfer circuit 310 can be implemented independently of the ECU, for example, as another vehicle system.

Data transfer circuit 310 can be configured to evaluate one or more mobile APs to determine their respective data storage capacity and signal strength with respect to the ego vehicle. Data transfer circuit 310 may include a communication circuit 301 (including either or both of a wireless transceiver circuit 302 with an associated antenna 314 and wired input/output (I/O) interface 304 in this example), a decision and control circuit 303 (including a processor 306 and memory 308 in this example) and a power source 311 (which can include power supply). It is understood that the disclosed data transfer circuit 310 can be compatible with and support one or more standard or non-standard messaging protocols.

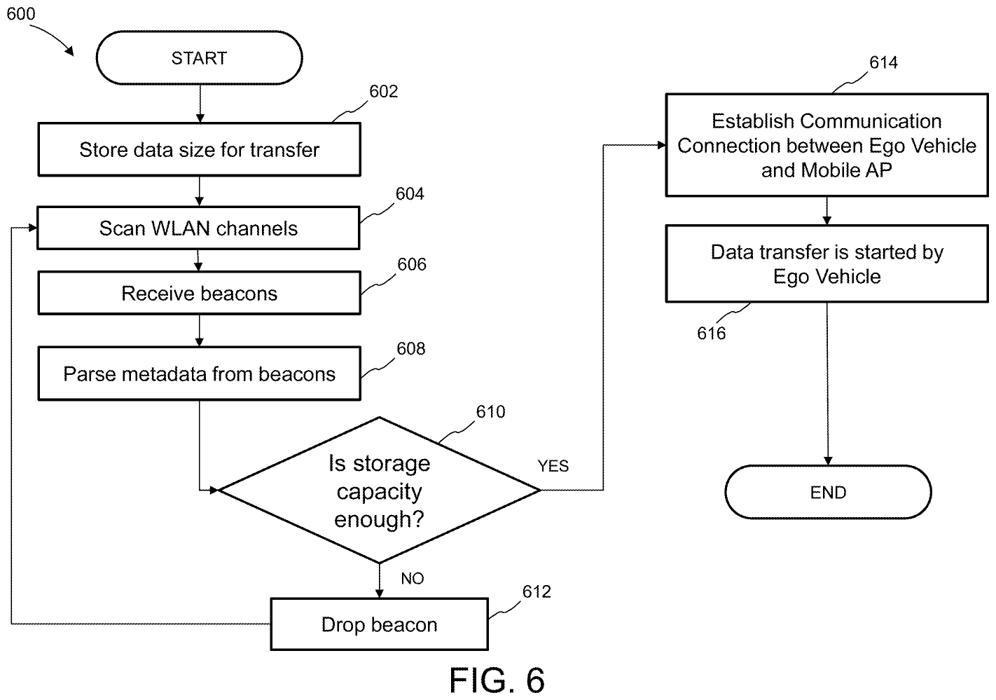

Components of data transfer circuit 310 are illustrated as communicating with each other via a data bus, although other communication in interfaces can be included. Decision and control circuit 303 can be configured to control one or more aspects of data, including data storage capacity, communication settings, identification information, and navigation information, to determine available data storage capacity and signal strength of a plurality of mobile APs, determine a plurality of available mobile APs that have an amount of data storage capacity sufficient to receive and hold data of an ego vehicle, and evaluate the plurality of available mobile APs to determine a designated mobile AP to receive the data of the ego vehicle. Decision and control circuit 303 can be configured to execute one or more steps described with reference to FIGS. 6, 7, 8, and 9.

Processor 306 can include a GPU, CPU, microprocessor, or any other suitable processing system. Processor 306 may include one or more single core or multicore processors. Processor 306 executes instructions 309 stored in a non-transitory computer readable medium, such as memory 308. Memory 308 may contain instructions 309 (e.g., program logic) executable by processor 306 to execute various functions of data transfer system 300, including those of vehicle systems and subsystems. Memory 308 may contain additional instructions as well, including instructions to transmit data to, receive data from, interact with, and control one or more of the sensors 320 and vehicle systems 350. In addition to the instructions, memory 308 may store data and other information used by the data transfer system 300 and its systems and subsystems for operation. For example, memory 308 can include data that has been communicated to the ego vehicle (e.g. via V2X communication), navigation data, communication data, data storage information, vehicle dynamics data, computer vision recognition data, and other data which can be useful for the execution of one or more determination of a plurality of mobile APs near or around the ego vehicle, determine available data storage capacity and signal strength of each of the plurality of mobile APs, determine a plurality of available mobile APs that have an amount of data storage capacity sufficient to receive and hold data of the ego vehicle, and evaluate the plurality of available mobile APs to determine a designated mobile AP to receive the data of the ego vehicle.

The memory 308 may include one or more various forms of memory or data storage (e.g., flash, RAM, etc.) that may be used to store the calibration parameters, images (analysis or historic), point parameters, instructions and variables for processor 306 as well as any other suitable information. Memory 308 can be made up of one or more modules of one or more different types of memory, and may be configured to store data and other information as well as operational instructions 309 that may be used by the processor 306 to execute one or more functions of data transfer circuit 310. For example, data and other information can include vehicle infrastructure data (i.e., the parameters of an ego vehicle), road data (i.e., the condition and features of roads), traffic data (i.e., the condition and status of traffic), navigation data (i.e., the navigational settings and trajectory of vehicles), etc. The data can also include values for signals of one or more sensors 320 useful in determining traffic data (i.e., congestion, time delay, detours, etc.), navigation data (i.e., the navigational settings and trajectory of vehicles), road data (i.e., the condition and features of roads), and environment data (i.e., the weather, landscape, obstacles, etc.). Operational instruction 309 can contain instructions for executing logical circuits, models, and methods as described herein.

Although the example of FIG. 3 is illustrated using processor and memory circuitry, as described below with reference to circuits disclosed herein, decision and control circuit 303 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a data transfer circuit 310. Components of decision and control circuit 303 can be distributed among two or more decision and control circuits 303, performed on other circuits described with respect to data transfer circuit 310, be performed on devices (such as cell phones), performed on a cloud-based platform (e.g., part of infrastructure), performed on distributed elements of the navigation and mapping network 360, such as at multiple vehicles, user device, central servers, performed on an edge-based platform, and performed on a combination of the foregoing.

Communication circuit 301 may include either or both a wireless transceiver circuit 302 with an associated antenna 314 and a wired I/O interface 304 with an associated hardwired data port (not illustrated). As this example illustrates, communications with data transfer circuit 310 can include either or both wired and wireless communications circuits 301. Wireless transceiver circuit 302 can include a transmitter and a receiver (not shown), e.g., a signal detection and verification broadcast mechanism, to allow wireless communications via any of a number of communication protocols such as, for example, WiFi (e.g., IEEE 802.11 standard), Bluetooth®, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by data transfer circuit 310 to/from other components of the ego vehicle, such as sensors 320, vehicle systems 350, infrastructure (e.g., servers cloud-based systems), and other devices or elements of navigation and mapping network 360. These RF signals can include information of almost any sort that is sent or received by the ego vehicle.

Wired I/O interface 304 can include a transmitter and a receiver (not shown) for hardwired communications with other devices. For example, wired I/O interface 304 can provide a hardwired interface to other components, including sensors 320 and vehicle systems 350. Wired I/O interface 304 can communicate with other devices using Ethernet or any of a number of other wired communication protocols whether standardized, proprietary, open, point-to-point, networked or otherwise.

Power source 311 such as one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, another vehicle battery, alternator, etc.), an energy harvester (e.g., solar cells, piezoelectric system, etc.), or it can include any other suitable power supply. It is understood power source 311 can be coupled to a power source of the ego vehicle, such as a battery and alternator. Power source 311 can be used to power the data transfer circuit 310.

Sensors 320 can include one or more of the previously mentioned sensors 220 of FIG. 2. Sensors 320 can include one or more sensors that may or not otherwise be included on a standard vehicle (e.g., vehicle 200) with which the data transfer circuit 310 is implemented. In the illustrated example, sensors 320 include vehicle acceleration sensors 312, vehicle speed sensors 314, wheelspin sensors 316 (e.g., one for each wheel), a tire pressure monitoring system (TPMS) 320, accelerometers such as a 3-axis accelerometer 322 to detect roll, pitch and yaw of the vehicle, vehicle clearance sensors 324, left-right and front-rear slip ratio sensors 326, environmental sensors 328 (e.g., to detect weather, salinity or other environmental conditions), and camera(s) 313 (e.g., front rear, side, top, bottom facing). Additional sensors 319 can also be included as may be appropriate for a given implementation data transfer system 300.

Vehicle systems 350 can include any of a number of different vehicle components or subsystems used to control or monitor various aspects of the ego vehicle and its performance. For example, it can include any or all of the aforementioned vehicle systems 230 and control systems 240 shown in FIG. 2. The communication system 340 of vehicle systems 350 may control components, such as sensors and communication circuits, of an ego vehicle to collect, store, and transfer data of the ego vehicle. In this example, the vehicle systems 350 may include a GPS or other vehicle positioning system 218.

During operation, data transfer circuit 310 can receive information from various vehicle sensors 320, vehicle systems 350, and navigation and mapping network 360 to receive information, such as metadata, from a mobile access point (AP) of a plurality of mobile APs, determine, based on the information from the mobile AP, available storage capacity of the mobile AP to receive sender data of an ego vehicle, in response to determining the available storage capacity of the mobile AP is an amount sufficient to receive the sender data of the ego vehicle, evaluate the mobile AP amongst a plurality of available mobile APs with sufficient available storage capacity to receive the sender data of the ego vehicle, select, based on the evaluation, a designated mobile AP to receive the sender data, and send the sender data of the ego vehicle to the designated mobile AP. Also, the driver, owner, and operator of the ego vehicle may manually trigger one or more processes described herein for determining available data storage capacity and signal strength of a plurality of mobile APs, determining a plurality of available mobile APs that have an amount of data storage capacity sufficient to receive and hold data of an ego vehicle, evaluating the plurality of available mobile APs, and selecting a designated mobile AP to receive the data of the ego vehicle. Communication circuit 301 can be used to transmit and receive information between the data transfer circuit 310, sensors 320 and vehicle systems 350. Also, sensors 320 and data transfer circuit 310 may communicate with vehicle systems 350 directly or indirectly (e.g., via communication circuit 301 or otherwise). Communication circuit 301 can be used to transmit and receive information between data transfer circuit 310, one or more other systems of an ego vehicle (i.e., vehicle 200), but also other elements of a navigation and mapping network 360, such as vehicles, devices (e.g., mobile phones), systems, networks (such as a communications network and central server), and infrastructure.

In various applications, communication circuit 301 can be configured to receive data and other information from sensors 320, vehicle systems 350, and navigation and mapping network 360 that is used to receive information, such as metadata, from a mobile access point (AP) of a plurality of mobile APs, determine, based on the information from the mobile AP, available storage capacity of the mobile AP to receive sender data of an ego vehicle, in response to determining the available storage capacity of the mobile AP is an amount sufficient to receive the sender data of the ego vehicle, evaluate the mobile AP amongst a plurality of available mobile APs with sufficient available storage capacity to receive the sender data of the ego vehicle, select, based on the evaluation, a designated mobile AP to receive the sender data, and send the sender data of the ego vehicle to the designated mobile AP. As one example, when data is received from an element of navigation and mapping network 360 (such as from a driver's user device), communication circuit 301 can be used to send an activation signal and activation information to one or more vehicle systems 350 or sensors 320 for the ego vehicle to determine a plurality of mobile APs around the ego vehicle, determine available data storage capacity and signal strength of each of the plurality of mobile APs, and determine the navigational settings and trajectory of each of the plurality of mobile APs. For example, it may be useful for vehicle systems 350, navigation and mapping network 360 or sensors 320 to provide data useful in determining a plurality of mobile APs around the ego vehicle, determining available data storage capacity and signal strength of each of the plurality of mobile APs, and determining the navigational settings and trajectory of each of the plurality of mobile APs.

Alternatively, data transfer circuit 310 can be continuously receiving information from vehicle system 350, sensors 320, other vehicles, devices and infrastructure (e.g., those that are elements of navigation and mapping network 360). Further, upon receiving new information, such as, for example, data of additional mobile APs and new navigational settings and trajectories of mobile APs, communication circuit 301 can send a signal to other components of the ego vehicle, infrastructure, or other elements of the navigation and mapping network 360 based on the new data on the mobile APs. For example, the communication circuit 301 can send a signal to a vehicle system 350 that indicates a control input for performing one or more calculations and analysis of data storage capacity, signal strength, and navigational trajectory of one or more mobile APs, such as, for example, vehicles surrounding the ego vehicle. The calculations and analysis of the data storage capacity, signal strength, and navigational trajectory of one or more mobile APs, may be used to determine a designated mobile AP to send data of the ego vehicle to.

The examples of FIGS. 2 and 3 are provided for illustration purposes only as examples of vehicle 200 and data transfer system 300 with which applications of the disclosed technology may be implemented. One of ordinary skill in the art reading this description will understand how the disclosed applications can be implemented with vehicle platforms.

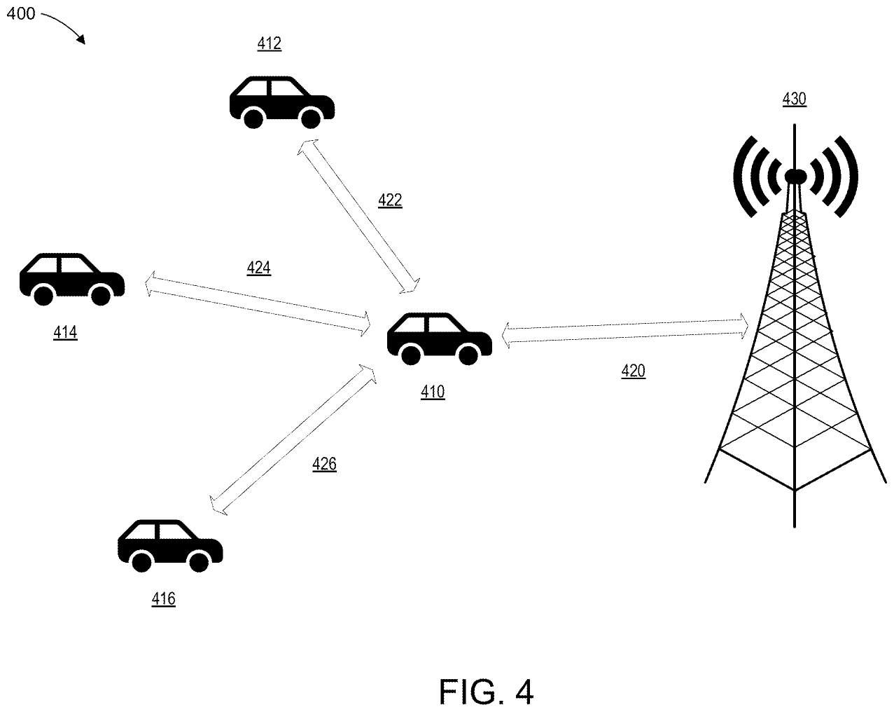

FIG. 4 illustrates an example network 400 that includes a plurality of vehicles, such as vehicles 410, 412, 414, and 416, and a plurality of base stations, such as base station 430. The plurality of vehicles 410, 412, 414, and 416 may each be a vehicle, such as an automobile, truck, motorcycle, bicycle, scooter, moped, recreational vehicle and other like on- or off-road vehicles. The vehicles 410, 412, 414, and 416 may each include a (wireless or wired) communication system, such as communication circuit 301 of FIG. 3, to communicate with each other, other vehicles, infrastructure elements, cloud components and other external entities using any of a number of communication protocols including, for example, V2V (vehicle-to-vehicle), V2I (vehicle-to-infrastructure) and V2X (vehicle-to-everything) protocols. Such a wireless communication system may allow vehicles 410, 412, 414, and 416 to receive information from other objects and vehicles including, for example, data storage capacity information, communication signal information, map data, data regarding infrastructure elements, navigation data, data regarding operation and intention of surrounding vehicles, and so on. A wireless communication system may allow vehicles 410, 412, 414, and 416 to receive updates to data that can be used to execute one or more vehicle control modes, and vehicle control algorithms. Wireless communication system may also allow vehicles 410, 412, 414, and 416 to transmit information to other objects and receive information from other objects (such as other vehicles, user devices, or infrastructure).

Here, vehicle 410 may be a mobile access point (AP), while the vehicles 412, 414, and 416 may be sender vehicles. A mobile AP may be a vehicle, computer, smartphone, or any mobile device that may be transported and includes wireless broadband coverage/communications to receive data from other vehicles and transmit data to an external data storage system or centralized database, such as, for example, a cloud database system. A sender vehicle may be a vehicle that may include wireless broadband coverage/communications to receive data from and transmit data to a mobile AP. As illustrated in FIG. 4, each of the sender vehicles 412, 414, and 416 may have established a communication link, such as communication connections 422, 424, and 426, respectively, with the mobile AP vehicle 410. Each of the sender vehicles 412, 414, and 416 may transmit data to the mobile AP vehicle 410 using communication connections 422, 424, and 426, respectively. The mobile AP vehicle 410 may store and retain the data retrieved from each of the sender vehicles 412, 414, and 416, if the mobile AP vehicle 410 has sufficient data storage capacity. By transmitting and transferring data to the mobile AP vehicle 410, the sender vehicles 412, 414, and 416 may free up their data storage capacity to enable the collection and storage of additional data. The mobile AP vehicle 410 may have a larger data storage capacity than each of the sender vehicles 412, 414, and 416.

The mobile AP vehicle 410 may be able to establish a communication link, such as communication connection 420, with a base station, such as base station 430. Base station 430 may be a tall, high-powered base station/cell tower that is able to maintain network signal strength across long/large distances. The mobile AP vehicle 410 may connect with base station 430 when the mobile AP vehicle 410 is located at a position that allows the mobile AP vehicle 410 to communicate with the base station 430. Such locations where the mobile AP vehicle 410 may be able to communicate with the base station 430 may include charging stations, workplaces, or a home base, where the mobile AP vehicle 410 may have a strong enough signal strength to communicate with the base station 430.

Once the mobile AP vehicle 410 is located at a position where communication connection 420 is established between the mobile AP vehicle 410 and the base station 430, data retained by the mobile AP vehicle 410 may be transferred to an external data storage system or centralized database, such as a cloud database system, using the base station 430. Transferring data from the mobile AP vehicle 410 to an external data storage system may free up the data storage capacity of the mobile AP vehicle 410. This may allow the mobile AP vehicle 410 to receive additional data from sender vehicles, thus continuing to free up data storage capacity of sender vehicles. As such, sender vehicles may efficiently and consistently collect data with minimum to no interferences caused by a lack of data storage capacity.

For a sender vehicle, such as sender vehicle 412, 414, and 416, to transmit its data to a mobile AP, such as mobile AP vehicle 410, the sender vehicle may first send out a signal to all mobile APs surrounding the sender vehicle. The signal may include information indicating that the sender vehicle has data to transmit and offload from its data storage. The sender vehicle may receive information from any number of mobile APs that are surrounding the sender vehicle. The sender vehicle may receive information from a mobile AP when the mobile AP is within a perimeter or distance from the sender vehicle. The perimeter or distance from the sender vehicle that a mobile AP may be within may be preset or adjusted according to one or more contributing factors, including the time of day, infrastructure of the sender vehicle, communication settings of the sender vehicle, navigation trajectory of the sender vehicle, etc. The information of the mobile AP may include metadata on the mobile AP. The metadata on the mobile AP may include the mobile AP's data storage capacity, including the total data storage capacity, the amount of available data storage capacity, the amount of data storage capacity reserved for incoming data, etc. The information, such as metadata, of the mobile AP may also include attributes and components of the mobile AP, including, for example, communication settings, identification information, navigation information, operating systems, and resources (e.g., CPU, memory, networking, applications, etc.). In this way, the sender vehicle may determine whether the mobile AP has a sufficient amount of available data storage capacity to receive and retain the data to be transmitted from the sender vehicle.

If the sender vehicle determines that the mobile AP does not have a sufficient amount of available data storage capacity to receive and retain the data to be transmitted, the sender vehicle may reject the establishment of a communication link with the mobile AP. If a communication link is already established between the sender vehicle and the mobile AP, then the sender vehicle may disconnect the communication link with the mobile AP upon a determination that the mobile AP has an insufficient amount of available data storage capacity to receive and retain the data of the sender vehicle to be transmitted. A sender vehicle may place any mobile AP that is determined to have insufficient data storage capacity on a list, such as a blacklist, of unavailable mobile APs for the sender vehicle. Mobile APs may remain on a blacklist for a particular period of time to allow the mobile APs to free up their data storage capacity. The particular period of time may be preset or adjusted based on one or more contributing factors, including the time of day, infrastructure of the sender vehicle, communication settings of the sender vehicle, navigation trajectory of the sender vehicle, etc. Each sender vehicle may have its own blacklist of mobile APs with insufficient data storage capacity. All mobile APs listed in a blacklist of a sender vehicle may be removed from the blacklist when the sender vehicle transmits its data to a mobile AP.

Alternatively, if the sender vehicle determines that the mobile AP does have a sufficient amount of available data storage capacity to receive and retain the data to be transmitted, the sender vehicle may establish or retain a communication link with the mobile AP. The sender vehicle may determine that a plurality of mobile APs each have a sufficient amount of available data storage capacity to receive and retain the data to be transmitted. When more than one mobile AP is determined to have a sufficient amount of available data storage capacity for the sender vehicle's data, the sender vehicle may evaluate each of the mobile APs to determine a designated mobile AP to establish a communication link with.

Evaluating a plurality of mobile APs, each with a sufficient available data storage capacity, may include determining and comparing the communication signal strength of each mobile AP with respect to the sender vehicle. The communication signal strength of a mobile AP may be based on the communication settings and navigation information of the respective mobile AP with respect to the sender vehicle. The communication settings may include the communication interface, protocols, components, and other communication capabilities and features of the mobile AP. The navigation information may include a current location, direction of movement, speed, travel duration, destination, and trajectory of the mobile AP. The communication signal strength of a mobile AP may further be based on whether the mobile AP includes an application for transferring data between vehicles, such as a data sending application, Wi-Fi setup application, wireless connection application, etc. Such an application may include components and interfaces that may increase the speed, efficiency, and strength in establishing and maintaining a communication link between a mobile AP and a sender vehicle, and with transmitting data between the sender vehicle and the mobile AP.

In one example, upon evaluating each of the plurality of mobile APs with sufficient available data storage capacity, the sender vehicle may select a mobile AP with an application for data transfer, such as, for example, a data sending application, a Wi-Fi setup application, a wireless connection application, etc. The sender vehicle may select a mobile AP with an application for data transfer that is active and available to support data to be transmitted between the sender vehicle and the mobile AP. If it is determined that a mobile AP with sufficient available data storage capacity either does not include an application for data transfer or includes an inactive and unavailable application for data transfer, the sender vehicle may reject the establishment of a communication link with the mobile AP. If a communication link is already established between the sender vehicle and the mobile AP, then the sender vehicle may disconnect the communication link with the mobile AP upon a determination that the mobile AP does not include an application for data transfer or the mobile AP does include an application for data transfer that is inactive and unavailable to support transmitting data.

A sender vehicle may place any mobile AP that is determined to either not include an application for data transfer or include an application for data transfer that is inactive and unavailable to support transmitting data on a list, such as a blacklist, of unavailable mobile APs for the sender vehicle. Mobile APs may remain on a list of unavailable of mobile APs for a particular period of time to allow the mobile APs to obtain an active and available application for data transfer. The particular period of time may be preset or adjusted based on one or more contributing factors, including the time of day, infrastructure of the sender vehicle, communication settings of the sender vehicle, navigation trajectory of the sender vehicle, etc. Each sender vehicle may have its own list, such as a blacklist, of unavailable mobile APs. All mobile APs listed in a blacklist of a sender vehicle may be removed from the blacklist when the sender vehicle transmits its data to a mobile AP.

Upon evaluating each of the plurality of mobile APs with sufficient available data storage capacity, the sender vehicle may select a mobile AP with the strongest communication signal strength to establish a communication link with. In this way, the sender vehicle may increase its likelihood in successfully transferring its data to the mobile AP with little to no interferences due to poor connections. To contribute to maintaining or increasing the signal strength and overall communication link between a sender vehicle and mobile AP while the sender vehicle is transmitting its data to the mobile AP, the sender data may adjust its navigational settings, including its speed and trajectory, to the navigational settings of the mobile AP. The sender data may obtain the navigational settings of the mobile AP from the information received from the mobile AP.

Once a communication link is established between a sender vehicle and a mobile AP, the sender vehicle may transmit its data to the mobile AP. When the mobile AP has received all of the transmitted data from the sender vehicle, the communication link between the sender vehicle and the mobile AP may be disconnected. The mobile AP and the sender vehicle may each continue traveling to their respective destinations. The sender vehicle may continue to collect, obtain and store data and may determine a next mobile AP to establish a communication link with and transmit data to when the sender vehicle's data storage capacity reaches a certain threshold. The threshold may be preset or adjusted according to one or more contributing factors, including the infrastructure of the vehicle. The mobile AP may establish connections with, and receive and retain additional data from other sender vehicles during the course of its travels. The mobile AP may obtain additional data until its data storage capacity reaches its limit, or until it reaches a location where it may connect to a base station to transmit all of the data to an external data storage system, such as a cloud database. Once the mobile AP has offloaded and transmitted its data to an external data storage system, the mobile AP may continue to establish connections with, and receive and retain additional data from other sender vehicles.

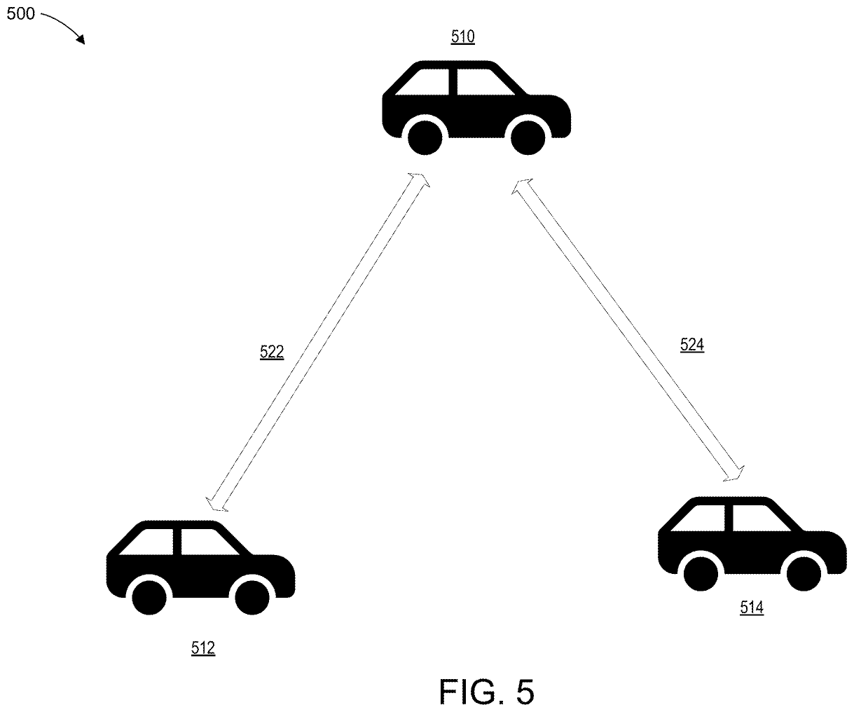

FIG. 5 illustrates an example network 500 that includes a plurality of vehicles, such as vehicles 510, 512, and 514. The plurality of vehicles 510, 512, and 514 may each be a vehicle, such as an automobile, truck, motorcycle, bicycle, scooter, moped, recreational vehicle and other like on- or off-road vehicles. The vehicles 510, 512, and 514 may each include a (wireless or wired) communication system, such as communication circuit 301 of FIG. 3, to communicate with each other, other vehicles, infrastructure elements, cloud components and other external entities using any of a number of communication protocols including, for example, V2V (vehicle-to-vehicle), V2I (vehicle-to-infrastructure) and V2X (vehicle-to-everything) protocols. Such a wireless communication system may allow vehicles 510, 512, and 514 to receive information from other objects and vehicles including, for example, data storage capacity information, communication signal information, map data, data regarding infrastructure elements, navigation data, data regarding operation and intention of surrounding vehicles, and so on. A wireless communication system may allow vehicles 510, 512, and 514 to receive updates to data that can be used to execute one or more vehicle control modes, and vehicle control algorithms. Wireless communication system may also allow vehicles 510, 512, and 514 to transmit information to other objects and receive information from other objects (such as other vehicles, user devices, or infrastructure).

Here, vehicle 510 may be a sender vehicle, while the vehicles 512 and 514 may be mobile access points (APs). A mobile AP may be a vehicle, computer, smartphone, or any mobile device that may be transported and includes wireless broadband coverage/communications to receive data from other vehicles and transmit data to an external data storage system or centralized database, such as, for example, a cloud database system. A sender vehicle may be a vehicle that may include wireless broadband coverage/communications to receive data from and transmit data to a mobile AP. As illustrated in FIG. 5, the sender vehicle 510 may have located the mobile AP vehicles 512 and 514. The sender vehicle 510 may establish as least one communication link 522 and 524 between mobile AP vehicles 512 and 514, respectively. The sender vehicle 510 may transmit data to the mobile AP vehicles 512 and 514 using communication connections 522 and 524, respectively. The mobile AP vehicles 512 and 514 may each store and retain the data retrieved from the sender vehicle 510, if the mobile AP vehicles 512 and 514 each have sufficient data storage capacity. By transmitting data to the mobile AP vehicles 512 and 514, the sender vehicle 510 may free up its data storage capacity to enable the collection and storage of additional data. The mobile AP vehicles 512 and 514 may each have a larger data storage capacity than the sender vehicle 510.

The mobile AP vehicles 512 and 514 may each be able to establish a communication link with a base station, such as connection link 420 to base station 430 of FIG. 4. A base station may be a tall, high-powered base station/cell tower that is able to maintain network signal strength across long/large distances. The mobile AP vehicles 512 and 514 may each connect with at least one base station when the mobile AP vehicles 512 and 514 are located at a position that allows each of the mobile AP vehicles 512 and 514 to communicate with a base station. Such locations where the mobile AP vehicles 512 and 514 may be able to communicate with a base station may include charging stations, workplaces, or home bases, where the mobile AP vehicles 512 and 514 may each have a strong enough signal strength to communicate with at least one base station.

Once the mobile AP vehicles 512 and 514 are each located at a position to establish a communication connection with at least one base station, data retained by the mobile AP vehicles 512 and 514 may be transferred to an external data storage system or centralized database, such as a cloud database system, using at least one base station. Transferring data from the mobile AP vehicles 512 and 514 to an external data storage system may free up the data storage capacity of each of the mobile AP vehicles 512 and 514. This may allow the mobile AP vehicles 512 and 514 to receive additional data from sender vehicles, thus continuing to free up data storage capacity of sender vehicles, such as sender vehicle 510. As such, sender vehicles may efficiently and consistently collect data with minimum to no interferences caused by a lack of data storage capacity.

For a sender vehicle, such as sender vehicle 510, to transmit its data to a mobile AP, such as mobile AP vehicles 512 and 514, the sender vehicle may first send out a signal to all mobile APs surrounding the sender vehicle. The signal may include information indicating that the sender vehicle 510 has data to transmit and offload from its data storage. The sender vehicle 510 may receive information from any number of mobile APs that are surrounding the sender vehicle. The sender vehicle 510 may receive information from a mobile AP when the mobile AP is within a perimeter or distance from the sender vehicle. The perimeter or distance from the sender vehicle 510 that a mobile AP may be within may be preset or adjusted according to one or more contributing factors, including the time of day, infrastructure of the sender vehicle, communication settings of the sender vehicle, navigation trajectory of the sender vehicle, etc. The mobile AP vehicles 512 and 514 may each be mobile APs that are with a perimeter or distance from the sender vehicle. The information of the mobile AP vehicles 512 and 514 may include metadata on each of the mobile APs. The metadata on a mobile AP may include data storage capacity, including the total data storage capacity, the amount of available data storage capacity, the amount of data storage capacity reserved for incoming data, etc. The information, such as metadata, of a mobile AP may also include attributes and components of the mobile AP, including, for example, communication settings, identification information, navigation information, operating systems, and resources (e.g., CPU, memory, networking, applications, etc.). In this way, the sender vehicle 510 may determine whether the mobile AP vehicles 512 and 514 each have a sufficient amount of available data storage capacity to receive and retain the data to be transmitted from the sender vehicle.

If the sender vehicle 510 determines that any of the mobile AP vehicles 512 and 514 do not have a sufficient amount of available data storage capacity to receive and retain the data to be transmitted, the sender vehicle may reject the establishment of a communication link with the respective mobile AP. If a communication link is already established between the sender vehicle 510 and the mobile AP with insufficient available data storage capacity, then the sender vehicle 510 may disconnect the communication link with the respective mobile AP upon a determination that the respective mobile AP has an insufficient amount of available data storage capacity to receive and retain the data of the sender vehicle 510 to be transmitted. Sender vehicle 510 may place any mobile AP that is determined to have insufficient data storage capacity on a list, such as a blacklist, of unavailable mobile APs for the sender vehicle 510. Each sender vehicle may have its own blacklist of unavailable mobile APs with insufficient data storage capacity. Mobile APs may remain on a blacklist for a particular period of time to allow the mobile APs to free up their data storage capacity. The particular period of time may be preset or adjusted based on one or more contributing factors, including the time of day, infrastructure of the sender vehicle, communication settings of the sender vehicle, navigation trajectory of the sender vehicle, etc. All mobile APs listed in a blacklist of sender vehicle 510 may be removed from the blacklist when the sender vehicle 510 transmits its data to a mobile AP.

Alternatively, if the sender vehicle 510 determines that any of the mobile AP vehicles 512 and 514 have a sufficient amount of available data storage capacity to receive and retain the data to be transmitted, the sender vehicle 510 may establish or retain a communication link with the respective mobile AP. The sender vehicle 510 may determine that a plurality of mobile APs each have a sufficient amount of available data storage capacity to receive and retain the data to be transmitted. When more than one mobile AP is determined to have a sufficient amount of available data storage capacity for the sender vehicle's 510 data, the sender vehicle 510 may evaluate each of the mobile APs to determine a designated mobile AP to establish a communication link with.

Evaluating a plurality of mobile APs, each with a sufficient available data storage capacity, may include determining and comparing the communication signal strength of each mobile AP with respect to the sender vehicle 510. The communication signal strength of a mobile AP may be based on the communication settings and navigation information of the respective mobile AP with respect to the sender vehicle 510. The communication settings may include the communication interface, protocols, components, and other communication capabilities and features of the mobile AP. The navigation information may include a current location, direction of movement, speed, travel duration, destination, and trajectory of the mobile AP. The communication signal strength of a mobile AP may further be based on whether the mobile AP includes an application for transferring data between vehicles, such as, for example, a Wi-Fi setup application, data sending application, wireless connection application, etc. Such an application may include components and interfaces that may increase the speed, efficiency, and strength in establishing and maintaining a communication link between a mobile AP and sender vehicle 510, and with transmitting data between the sender vehicle 510 and the mobile AP.

In one example, upon evaluating each of the plurality of mobile APs with sufficient available data storage capacity, the sender vehicle 510 may select a mobile AP with an application for data transfer, such as, for example, a data sending application, a Wi-Fi setup application, a wireless connection application, etc. The sender vehicle 510 may select a mobile AP with an application for data transfer that is active and available to support data to be transmitted between the sender vehicle 510 and the mobile AP. If it is determined that a mobile AP with sufficient available data storage capacity either does not include an application for data transfer or includes an application for data transfer that is inactive and unavailable, the sender vehicle 510 may reject the establishment of a communication link with the mobile AP. If a communication link is already established between the sender vehicle 510 and the mobile AP, then the sender vehicle 510 may disconnect the communication link with the mobile AP upon a determination that the mobile AP does not include an application for data transfer or the mobile AP does include an application for data transfer that is inactive and unavailable to support transmitting data.

A sender vehicle 510 may place any mobile AP that is determined to either not include an application for data transfer or include an application for data transfer that is inactive and unavailable to support transmitting data on a list, such as a blacklist, of unavailable mobile APs for the sender vehicle 510. Mobile APs may remain on a list of unavailable of mobile APs for a particular period of time to allow the mobile APs to obtain an active and available application for data transfer. The particular period of time may be preset or adjusted based on one or more contributing factors, including the time of day, infrastructure of the sender vehicle 510, communication settings of the sender vehicle 510, navigation trajectory of the sender vehicle 510, etc. Each sender vehicle, such as sender vehicle 510, may have its own list, such as a blacklist, of unavailable mobile APs. All mobile APs listed in a blacklist of a sender vehicle, such as sender vehicle 510, may be removed from the blacklist when the sender vehicle transmits its data to a mobile AP.

Here, sender vehicle 510 may obtain information of mobile AP vehicle 512 and information of mobile AP vehicle 514. The sender vehicle may determine that each of mobile AP vehicles 512 and 514 have sufficient data storage capacity to receive and retain data from the sender vehicle 510. Before establishing a communication link with at least one of the mobile AP vehicles 512 and 514, the sender vehicle 510 may evaluate each of the mobile AP vehicles 512 and 514 to determine which mobile AP vehicle has the strongest communication signal strength to establish a communication link with. In this way, the sender vehicle 510 may increase its likelihood in successfully transmitting its data to a mobile AP with little to no interferences due to poor connections. To contribute to maintaining or increasing the signal strength and overall communication link between a sender vehicle and mobile AP while the sender vehicle is transmitting its data to the mobile AP, the sender data may adjust its navigational settings, including its speed and trajectory, to the navigational settings of the mobile AP. The sender data may obtain the navigational settings of the mobile AP from the information received from the mobile AP.

In one example, the sender vehicle 510 may determine that mobile AP vehicle 512 has a larger amount of available data storage capacity than mobile AP vehicle 514. However, the sender vehicle 510 may further evaluate the mobile AP vehicles 512 and 514, and determine that the mobile AP vehicle 512 has a weak communication signal strength, while the mobile AP vehicle 514 has a strong communication signal strength. The sender vehicle 510 may select the mobile AP vehicle 514 to establish a communication link with and transmit data to. In another example, the sender vehicle 510 may determine that mobile AP vehicle 514 has a stronger communication signal strength than mobile AP vehicle 512. However, the sender vehicle 510 may further evaluate the mobile AP vehicles 512 and 514, and determine that the mobile AP vehicle 514 has an insufficient amount of available data storage capacity to receive data from the sender vehicle 510, while the mobile AP vehicle 512 has a sufficient amount of available data storage capacity to receive data form the sender vehicle 510. The sender vehicle 510 may select the mobile AP vehicle 512 to establish a communication link with and transmit data to. Many variations are possible.

Once a communication link is established between sender vehicle 510 and a mobile AP, the sender vehicle 510 may transmit its data to the respective mobile AP. When the mobile AP has received all of the transmitted data from the sender vehicle 510, the communication link between the sender vehicle 510 and the mobile AP may be disconnected. The mobile AP and the sender vehicle 510 may each continue traveling to their respective destinations. The sender vehicle 510 may continue to collect, obtain and store data and may determine a next mobile AP to establish a communication link with and transmit data to when the sender vehicle's 510 data storage capacity reaches a certain threshold. The threshold may be preset or adjusted according to one or more contributing factors, including the infrastructure of the vehicle. The mobile AP may establish connections with, and receive and retain additional data from other sender vehicles during the course of its travels. The mobile AP may obtain additional data until its data storage capacity reaches its limit, or until it reaches a location where it may connect to a base station to transmit all of the data to an external data storage system, such as a cloud database. Once the mobile AP has offloaded and transmitted its data to an external data storage system, the mobile AP may continue to establish connections with, and receive and retain additional data from other sender vehicles.

FIG. 6 illustrates an example process 600 that includes one or more steps that may be performed to identify a mobile access point (AP) with sufficient data storage capacity for an ego vehicle to send data to. In some applications, the process 600 can be executed, for example by the computing component 110 of FIG. 1. In another application, the process 600 may be implemented as the computing component 110 of FIG. 1. In other applications, the process 600 may be implemented as, for example, the computing system 210 of FIG. 2, and the data transfer system 300 of FIG. 3. The process 600 may include a server.

At step 602, the computing component 110 may evaluate the data collected/retained by the ego vehicle. Evaluating the data may determine the amount of data that needs to be offloaded from the ego vehicle and transmitted to a mobile AP, such as a vehicle AP. Once the data to be transmitted is determined, such data may be tagged and compartmentalized in the data storage as data ready to be transmitted. The data may further be tagged with the amount of data storage capacity needed by a mobile AP to receive and retain such data.

At step 604, the computing component 110 may scan all communication networks, such as wireless local area networks (WLANs), to search for one or more mobile APs near and around the ego vehicle. A signal may be sent out over one or more communication networks to one or more mobile APs. The signal may include information indicating that the sender vehicle has data to transmit and offload from its data storage.

At step 606, the computing component 110 may receive communication beacons from a mobile AP that is near and around the ego vehicle. Each communication beacon may be from a single, mobile AP and include information on the mobile AP. The information on a mobile AP may include metadata on the respective mobile AP's data storage capacity, including the total data storage capacity, the amount of available data storage capacity, the amount of data storage capacity reserved for incoming data, etc. The information, such as metadata, of the mobile AP may also include attributes and components of the mobile AP, including, for example, communication settings, identification information, navigation information, operating systems, and resources (e.g., CPU, memory, networking, applications, etc.). In this way, the ego vehicle may determine whether the mobile AP has a sufficient amount of available data storage capacity to receive and retain the data to be transmitted from the ego vehicle. The computing component 110 may receive a communication beacon from a mobile AP when the mobile AP is within a perimeter or distance from the sender vehicle. The perimeter or distance from the sender vehicle that a mobile AP may be within may be preset or adjusted according to one or more contributing factors, including the time of day, infrastructure of the sender vehicle, communication settings of the sender vehicle, navigation trajectory of the sender vehicle, etc.

At step 608, the computing component 110 may parse the metadata from the information received from the communication beacons of the mobile AP to determine the amount of available data storage capacity that the mobile AP contains. The computing component 110 may further parse the metadata from the information received from the communication beacons to determine other characteristics and features of the mobile AP that may be a contributing factor in evaluating the mobile AP's abilities in receiving the data of the ego vehicle.

At step 610, the computing component 110 may determine if the mobile AP contains a sufficient amount of available data storage capacity to receive and retain the data from the ego vehicle. If the computing component 110 determines that the mobile AP does not have a sufficient amount of available data storage capacity to receive and retain the data of the ego vehicle, the computing component 110 may proceed to step 612. Otherwise, if the computing component 110 determines that the mobile AP does have a sufficient amount of available data storage capacity to receive and retain the data of the ego vehicle, the computing component 110 may proceed to step 614.

At step 612, the computing component 110 may drop the communication beacon of the mobile AP upon a finding that the mobile AP does not have a sufficient amount of available data storage capacity for the data of the ego vehicle. Dropping the communication beacon of the mobile AP may include placing the mobile AP with insufficient data storage capacity on a list, such as a blacklist, of unavailable mobile APs for the ego vehicle. Mobile APs may remain on a blacklist for a particular period of time to allow the mobile APs to free up their data storage capacity. The particular period of time may be preset or adjusted based on one or more contributing factors, including the time of day, infrastructure of the sender vehicle, communication settings of the sender vehicle, navigation trajectory of the sender vehicle, etc. The ego vehicle may have its own blacklist of mobile APs with insufficient data storage capacity. All mobile APs listed in the blacklist of the ego vehicle may be removed from the blacklist when the ego vehicle transmits and offloads its data to a mobile AP. Once the mobile AP is dropped, the computing component 110 may proceed to step 604 to scan all communication networks, such as wireless local area networks (WLANs), to search for another mobile AP near and around the ego vehicle.

At step 614, the computing component 110 may establish a communication connection link between the ego vehicle and the mobile AP. Establishing a communication link between the ego vehicle and the mobile AP may allow the data of the ego vehicle to be transmitted from the ego vehicle to the mobile AP.

At step 616, the computing component 110 may transmit the data of the ego vehicle to the mobile AP after the communication link between the ego vehicle and the mobile AP is established. When the mobile AP has received all of the transmitted data from the ego vehicle, the communication link between the ego vehicle and the mobile AP may be disconnected. The mobile AP and the ego vehicle may each continue traveling to their respective destinations. The ego vehicle may continue to collect, obtain and store data and may determine a next mobile AP to establish a communication link with and transmit data to when the ego vehicle's data storage capacity reaches a certain threshold. The threshold may be preset or adjusted according to one or more contributing factors, including the infrastructure of the vehicle.

The mobile AP may establish connections with, and receive and retain additional data from other sender vehicles during the course of its travels. The mobile AP may obtain additional data until its data storage capacity reaches its limit, or until it reaches a location where it may connect to a base station to transmit all of the data to an external data storage system, such as a cloud database. Once the mobile AP has offloaded and transmitted its data to an external data storage system, the mobile AP may continue to establish connections with, and receive and retain additional data form other sender vehicles.

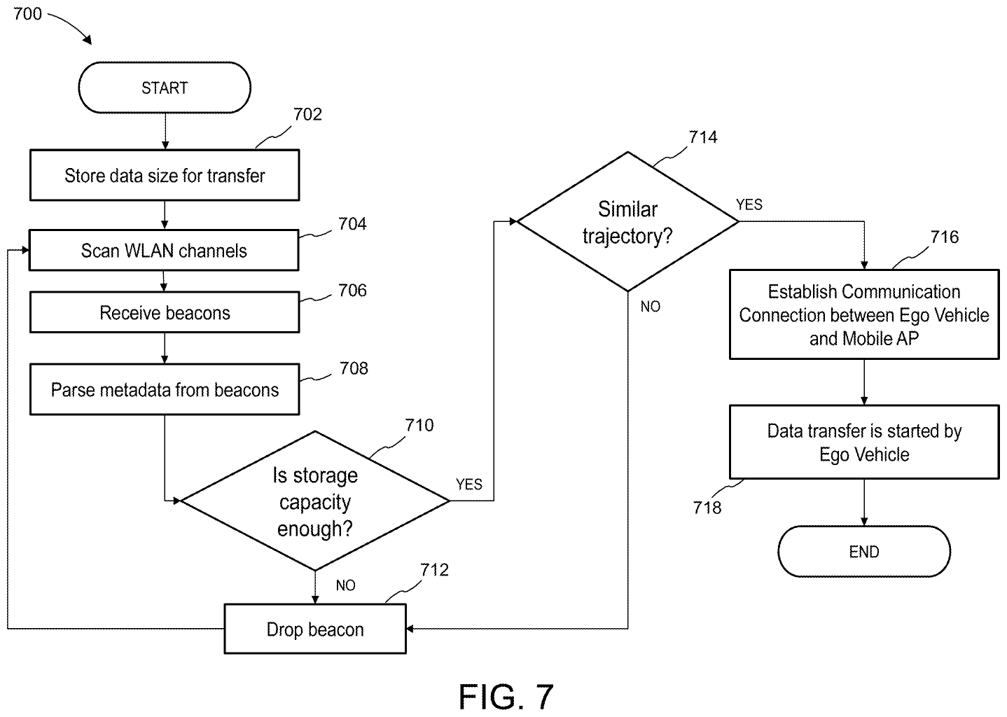

FIG. 7 illustrates an example process 700 that includes one or more steps that may be performed to identify a mobile access point (AP) with sufficient data storage capacity for an ego vehicle to send data to. In some applications, the process 700 can be executed, for example by the computing component 110 of FIG. 1. In another application, the process 700 may be implemented as the computing component 110 of FIG. 1. In other applications, the process 700 may be implemented as, for example, the computing system 210 of FIG. 2, and the data transfer system 300 of FIG. 3. The process 700 may include a server.

At step 702, the computing component 110 may evaluate the data collected/retained by the ego vehicle. Evaluating the data may determine the amount of data that needs to be offloaded from the ego vehicle and transmitted to a mobile AP, such as a vehicle AP. Once the data to be transmitted is determined, such data may be tagged and compartmentalized in the data storage as data ready to be transmitted. The data may further be tagged with the amount of data storage capacity needed by a mobile AP to receive and retain such data.

At step 704, the computing component 110 may scan all communication networks, such as wireless local area networks (WLANs), to search for one or more mobile APs near and around the ego vehicle. A signal may be sent out over one or more communication networks to one or more mobile APs. The signal may include information indicating that the sender vehicle has data to transmit and offload from its data storage.

At step 706, the computing component 110 may receive communication beacons from a mobile AP that is near and around the ego vehicle. Each communication beacon may be from a single, mobile AP and include information on the mobile AP. The information on a mobile AP may include metadata on the respective mobile AP's data storage capacity. The metadata on a mobile AP may include the total data storage capacity, the amount of available data storage capacity, the amount of data storage capacity reserved for incoming data, etc. The information, such as metadata, of the mobile AP may also include attributes and components of the mobile AP, including, for example, communication settings, identification information, navigation information, operating systems, and resources (e.g., CPU, memory, networking, applications, etc.). In this way, the ego vehicle may determine whether the mobile AP has a sufficient amount of available data storage capacity to receive and retain the data to be transmitted from the ego vehicle. The computing component 110 may receive a communication beacon from a mobile AP when the mobile AP is within a perimeter or distance from the sender vehicle. The perimeter or distance from the sender vehicle that a mobile AP may be within may be preset or adjusted according to one or more contributing factors, including the time of day, infrastructure of the sender vehicle, communication settings of the sender vehicle, navigation trajectory of the sender vehicle, etc.

At step 708, the computing component 110 may parse the metadata from the information received from the communication beacons of the mobile AP to determine the amount of available data storage capacity that the mobile AP contains. The computing component 110 may further parse the metadata from the information received from the communication beacons to determine other characteristics and features of the mobile AP that may be a contributing factor in evaluating the mobile AP's abilities in receiving the data of the ego vehicle. For example, the metadata of the mobile AP may be parsed to determine navigation information of the mobile AP with respect to the ego vehicle. The navigation information may include a current location, direction of movement, speed, travel duration, destination, and trajectory of the mobile AP. This navigation information of the mobile AP may be a contributing factor towards determining whether the mobile AP can efficiently and effectively establish and maintain a communication link with the ego vehicle, and with receive the data from the ego vehicle with little to no interferences.

At step 710, the computing component 110 may determine if the mobile AP contains a sufficient amount of available data storage capacity to receive and retain the data from the ego vehicle. If the computing component 110 determines that the mobile AP does not have a sufficient amount of available data storage capacity to receive and retain the data of the ego vehicle, the computing component 110 may proceed to step 712. Otherwise, if the computing component 110 determines that the mobile AP does have a sufficient amount of available data storage capacity to receive and retain the data of the ego vehicle, the computing component 110 may proceed to step 714.

At step 712, the computing component 110 may drop the communication beacon of the mobile AP upon a finding that the mobile AP does not have a sufficient amount of available data storage capacity for the data of the ego vehicle. The computing component 110 may drop the communication beacon of the mobile AP upon a finding that the mobile AP does not have a similar trajectory to the ego vehicle. Dropping the communication beacon of the mobile AP may include placing the mobile AP with either insufficient data storage capacity or unsimilar trajectory on a list, such as a blacklist, of unavailable mobile APs for the ego vehicle. Mobile APs may remain on a blacklist of unavailable mobile APs for a particular period of time to allow the mobile APs to free up their data storage capacity. The particular period of time may be preset or adjusted based on one or more contributing factors, including the time of day, infrastructure of the sender vehicle, communication settings of the sender vehicle, navigation trajectory of the sender vehicle, etc. The ego vehicle may have its own blacklist of mobile APs with insufficient data storage capacity and of mobile APs with unsimilar trajectories from the ego vehicle. All mobile APs listed in a blacklist of the ego vehicle may be removed from the blacklist when the ego vehicle transmits and offloads its data to a mobile AP. Once the mobile AP is dropped, the computing component 110 may proceed to step 704 to scan all communication networks, such as wireless local area networks (WLANs), to search for another mobile AP near and around the ego vehicle.

At step 714, the computing component 110 may determine if the mobile AP has a similar trajectory to the ego vehicle. The navigation information of the mobile AP obtained from the metadata parsed from the communication beacons may be analyzed to determine a current location, direction of movement, speed, travel duration, destination, and trajectory of the mobile AP. Such information may be used to determine if the mobile AP may have a similar trajectory to the ego vehicle. Having similar trajectories between the ego vehicle and the mobile AP may allow the ego vehicle and mobile AP to stay in close proximity to one another during their individual travels. The closer the ego vehicle and mobile AP are, the stronger the communication signal may be between the ego vehicle and the mobile AP. The signal strength may be directly correlated to the strength and stability of a communication link between the ego vehicle and the mobile AP. The strength and stability of the communication link between the mobile AP and the ego vehicle may impact the speed and efficiency in transmitting data, thus increasing the likelihood in successfully transmitting all of the necessary data with little to no interferences due to poor connections. If the computing component 110 determines that the mobile AP does not have a similar trajectory to the ego vehicle, the computing component 110 may proceed to step 712. Otherwise, if the computing component 110 determines that the mobile AP does have a similar trajectory to the ego vehicle, the computing component 110 may proceed to step 716.

At step 716, the computing component 110 may establish a communication link between the ego vehicle and the mobile AP. A communication link between the ego vehicle and the mobile AP may be established upon a determination that the mobile AP has sufficient available data storage capacity to receive and retain the data of the ego vehicle, and has a navigational trajectory similar to the ego vehicle, to increase the likelihood of successfully and efficiently transmitting the data. Establishing a communication link between the ego vehicle and the mobile AP may allow the data of the ego vehicle to be transmitted from the ego vehicle to the mobile AP.

At step 718, the computing component 110 may transmit the data of the ego vehicle to the mobile AP after the communication link between the ego vehicle and the mobile AP is established. When the mobile AP has received all of the transmitted data from the ego vehicle, the communication link between the ego vehicle and the mobile AP may be disconnected. The mobile AP and the ego vehicle may each continue traveling to their respective destinations. The ego vehicle may continue to collect, obtain and store data and may determine a next mobile AP to establish a communication link with and transmit data to when the ego vehicle's data storage capacity reaches a certain threshold. The threshold may be preset or adjusted according to one or more contributing factors, including the infrastructure of the vehicle.

The mobile AP may establish connections with, and receive and retain additional data from other sender vehicles during the course of its travels. The mobile AP may obtain additional data until its data storage capacity reaches its limit, or until it reaches a location where it may connect to a base station to transmit all of the data to an external data storage system, such as a cloud database. Once the mobile AP has offloaded and transmitted its data to an external data storage system, the mobile AP may continue to establish connections with, and receive and retain additional data form other sender vehicles.

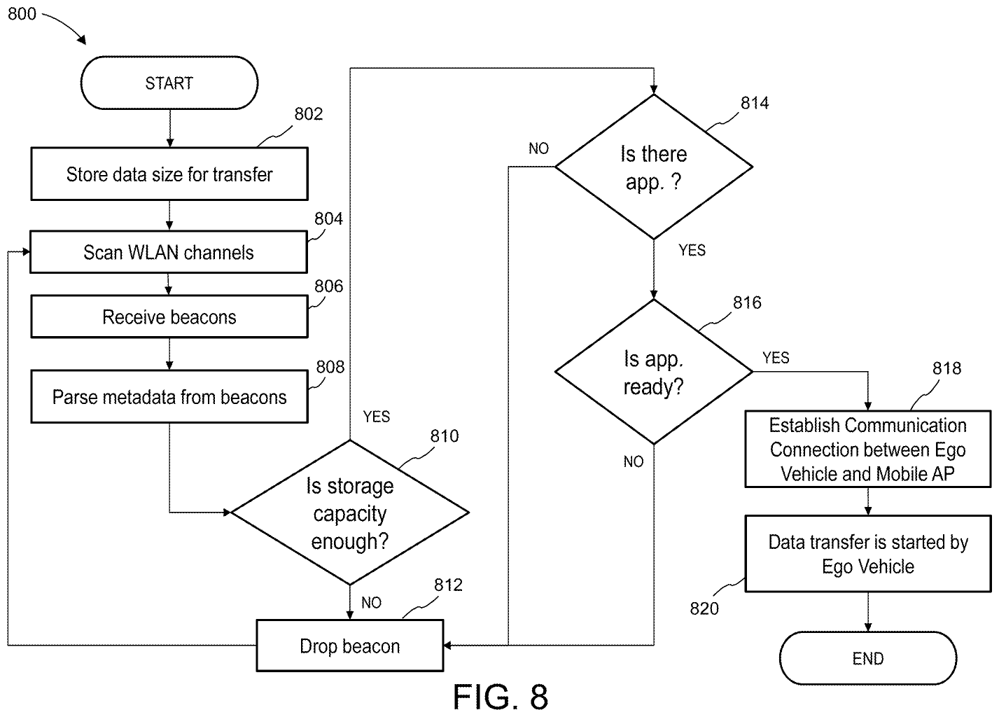

FIG. 8 illustrates an example process 800 that includes one or more steps that may be performed to identify a mobile access point (AP) with sufficient data storage capacity for an ego vehicle to send data to. In some applications, the process 800 can be executed, for example by the computing component 110 of FIG. 1. In another application, the process 800 may be implemented as the computing component 110 of FIG. 1. In other applications, the process 800 may be implemented as, for example, the computing system 210 of FIG. 2, and the data transfer system 300 of FIG. 3. The process 800 may include a server.

At step 802, the computing component 110 may evaluate the data collected/retained by the ego vehicle. Evaluating the data may determine the amount of data that needs to be offloaded from the ego vehicle and transmitted/transferred to a mobile AP, such as a vehicle AP. Once the data to be transmitted is determined, such data may be tagged and compartmentalized in the data storage as data ready to be transmitted. The data may further be tagged with the amount of data storage capacity needed by a mobile AP to receive and retain such data to be transmitted.

At step 804, the computing component 110 may scan all communication networks, such as wireless local area networks (WLANs), to search for one or more mobile APs near and around the ego vehicle. A signal may be sent out over one or more communication networks to one or more mobile APs. The signal may include information indicating that the sender vehicle has data to transmit and offload from its data storage.

At step 806, the computing component 110 may receive communication beacons from a mobile AP that is near and around the ego vehicle. Each communication beacon may be from a single, mobile AP and include information on the mobile AP. The information on a mobile AP may include metadata on the respective mobile AP. The metadata on the mobile AP may include, for example, data storage capacity, including the total data storage capacity, the amount of available data storage capacity, the amount of data storage capacity reserved for incoming data, etc. The information, such as metadata, of the mobile AP may also include attributes and components of the mobile AP, including, for example, communication settings, identification information, navigation information, operating systems, and resources (e.g., CPU, memory, networking, applications, etc.). In this way, the ego vehicle may determine whether the mobile AP has a sufficient amount of available data storage capacity to receive and retain the data to be transmitted from the ego vehicle. The computing component 110 may receive a communication beacon from a mobile AP when the mobile AP is within a perimeter or distance from the sender vehicle. The perimeter or distance from the sender vehicle that a mobile AP may be within may be preset or adjusted according to one or more contributing factors, including the time of day, infrastructure of the sender vehicle, communication settings of the sender vehicle, navigation trajectory of the sender vehicle, etc.

At step 808, the computing component 110 may parse the metadata from the information received from the communication beacons of the mobile AP to determine the amount of available data storage capacity that the mobile AP contains. The computing component 110 may further parse the metadata from the information received from the communication beacons to determine other characteristics and features of the mobile AP that may be a contributing factor in evaluating the mobile AP's abilities in receiving the data of the ego vehicle. For example, the metadata of the mobile AP may be parsed to determine communication settings of the mobile AP with respect to the ego vehicle. The communication settings may include the communication interface, protocols, components, and other communication capabilities and features of the mobile AP. The mobile AP may include a communication connection application, such as a Wi-Fi setup application. Such a communication connection application may include protocols, components and other features that may quickly, efficiently, and securely establish a communication link between the mobile AP and the ego vehicle. Using the communication connection application to establish a communication link may increase the likelihood of successfully transmitting data from the ego vehicle to the mobile AP with little to no interferences because of poor reception, increased latency, and noise disturbances.

At step 810, the computing component 110 may determine if the mobile AP contains a sufficient amount of available data storage capacity to receive and retain the data from the ego vehicle. If the computing component 110 determines that the mobile AP does not have a sufficient amount of available data storage capacity to receive and retain the data of the ego vehicle, the computing component 110 may proceed to step 812. Otherwise, if the computing component 110 determines that the mobile AP does have a sufficient amount of available data storage capacity to receive and retain the data of the ego vehicle, the computing component 110 may proceed to step 814.

At step 812, the computing component 110 may drop the communication beacon of the mobile AP upon a finding that the mobile AP does not have a sufficient amount of available data storage capacity for the data of the ego vehicle. The computing component 110 may drop the communication beacon of the mobile AP upon a finding that the mobile AP does not have an application for transferring data (e.g., Wi-Fi setup application, wireless connection application, data transfer application, etc.) to support in establishing a communication link with the ego vehicle and transmitting data between the ego vehicle and the mobile AP. The computing component 110 may drop the communication beacon of the mobile AP upon a finding that the mobile AP does have an application to support data transfer with the ego vehicle, but the application is not ready, active, and available to establish such a communication link with the ego vehicle and support data transfer between the ego vehicle and the mobile AP.

Dropping the communication beacon of the mobile AP may include placing the mobile AP with insufficient data storage capacity on a list, such as a blacklist, of unavailable mobile APs for the ego vehicle. Dropping the communication beacon of the mobile AP may include placing the mobile AP without an application to support data transfer on a list, such as a blacklist, of unavailable mobile APs for the ego vehicle. Dropping the communication beacon of the mobile AP may include placing the mobile AP with an inactive and unavailable application to support data transfer on a list, such as a blacklist, of unavailable mobile APs for the ego vehicle.

Mobile APs may remain on a blacklist for a particular period of time to allow the mobile APs to free up their data storage capacity and acquire an active and available application to support data transfer. The particular period of time may be preset or adjusted based on one or more contributing factors, including the time of day, infrastructure of the sender vehicle, communication settings of the sender vehicle, navigation trajectory of the sender vehicle, etc. The ego vehicle may have its own blacklist of mobile APs with insufficient data storage capacity. All mobile APs listed in the blacklist of the ego vehicle may be removed from the blacklist when the ego vehicle transmits and offloads its transfer data to a mobile AP.

Once the mobile AP is dropped, the computing component 110 may proceed to step 804 to scan all communication networks, such as wireless local area networks (WLANs), to search for another mobile AP near and around the ego vehicle.

At step 814, the computing component 110 may determine if the mobile AP has an application to support data transfer. The metadata parsed from the information received from the communication beacons of the mobile AP may be analyzed to determine if the mobile AP includes an application to support data transfer, such as a Wi-Fi setup application, data transfer application, wireless connection application, etc. Such an application may include protocols, components and other features that may quickly, efficiently, and securely establish a communication link and perform data transfer between the mobile AP and the ego vehicle. Using the application to establish a communication link may increase the likelihood of successfully transmitting data from the ego vehicle to the mobile AP with little to no interferences because of poor reception, increased latency, and noise disturbances.

If the computing component 110 determines that the mobile AP does not have an application to establish a communication link and support data transfer with the ego vehicle, the computing component 110 may proceed to step 812. Otherwise, if the computing component 110 determines that the mobile AP does have an application to establish a communication link and support data transfer with the ego vehicle, the computing component 110 may proceed to step 816.

At step 816, the computing component 110 may determine if the application is ready for use. Upon a determination that the mobile AP has an application to establish a communication link and support data transfer with the ego vehicle, it may be determined if such an application is ready for use. The application may be ready for use when it is active and available for use, including, for example, being powered on, having sufficient power to establish a communication link and perform data transfer, having sufficient signal strength to establish a communication link and perform data transfer, is not overheated from extensive use, is not damaged either externally or internally, etc. Conversely, the application may not be ready for use when it is inactive and unavailable, including, for example, being powered off, having insufficient power to establish a communication link and perform data transfer, having insufficient signal strength to establish a communication link and perform data transfer, is overheated from extensive use, is damaged either externally and/or internally, etc.

If the computing component 110 determines that the application of the mobile AP is not ready for use to establish a communication link and support data transfer with the ego vehicle, the computing component 110 may proceed to step 812. Otherwise, if the computing component 110 determines that the application of the mobile AP is ready for use to establish a communication link and support data transfer with the ego vehicle, the computing component 110 may proceed to step 818.

At step 818, the computing component 110 may establish a communication link between the ego vehicle and the mobile AP. A communication link between the ego vehicle and the mobile AP may be established upon a determination that the mobile AP has sufficient available data storage capacity to receive and retain the data of the ego vehicle, and has an application to support data transfer with the ego vehicle, to increase the likelihood of successfully and efficiently transmitting/transferring the data of the ego vehicle. Establishing a communication link between the ego vehicle and the mobile AP may allow the data of the ego vehicle to be transmitted from the ego vehicle to the mobile AP.

At step 820, the computing component 110 may transmit the data of the ego vehicle to the mobile AP after the communication link between the ego vehicle and the mobile AP is established. When the mobile AP has received all of the transmitted data from the ego vehicle, the communication link between the ego vehicle and the mobile AP may be disconnected. The mobile AP and the ego vehicle may each continue traveling to their respective destinations. The ego vehicle may continue to collect, obtain and store data and may determine a next mobile AP to establish a communication link with and transmit data to when the ego vehicle's data storage capacity reaches a certain threshold. The threshold may be preset or adjusted according to one or more contributing factors, including the infrastructure of the vehicle.

The mobile AP may establish connections with, and receive and retain additional data from other sender vehicles during the course of its travels. The mobile AP may obtain additional data until its data storage capacity reaches its limit, or until it reaches a location where it may connect to a base station to transmit all of the data to an external data storage system, such as a cloud database. Once the mobile AP has offloaded and transmitted its data to an external data storage system, the mobile AP may continue to establish connections with, and receive and retain additional data form other sender vehicles.

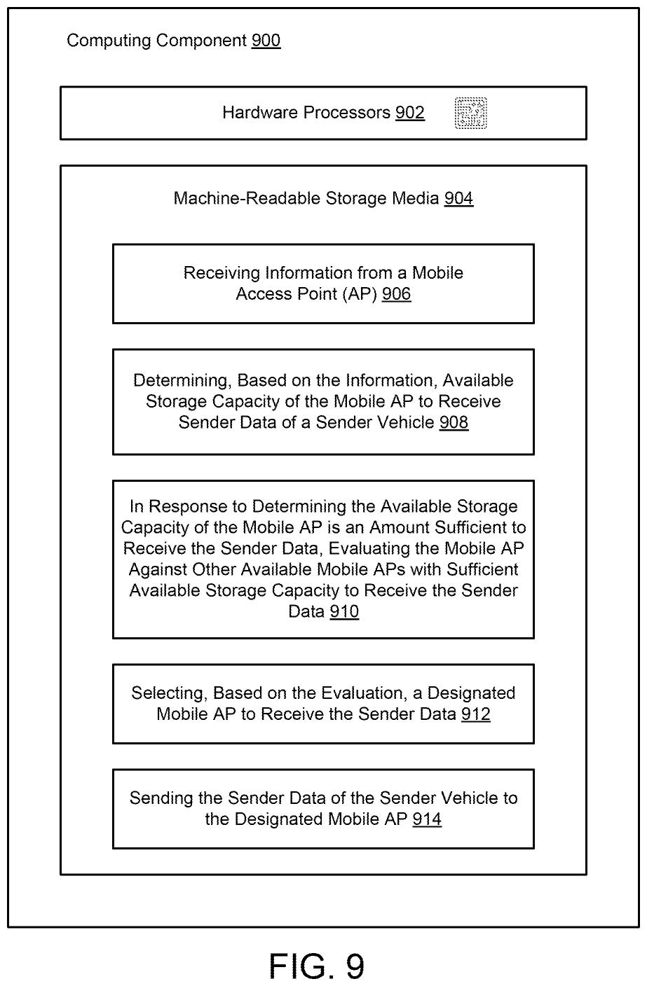

FIG. 9 illustrates an example computing component 900 that includes one or more hardware processors 902 and machine-readable storage media 904 storing a set of machine-readable/machine-executable instructions that, when executed, cause the hardware processor(s) 902 to perform an illustrative method of identifying a mobile access point (AP) with sufficient data storage capacity for a vehicle. It should be appreciated that there can be additional, fewer, or alternative steps performed in similar or alternative orders, or in parallel, within the scope of the various examples discussed herein unless otherwise stated. The computing component 900 may be implemented as the computing component 110 of FIG. 1, the computing system 210 of FIG. 2, the data transfer system 300 of FIG. 3, the process 600 of FIG. 6, the process 700 of FIG. 7, and the process 800 of FIG. 8.

At step 906, the hardware processor(s) 902 may execute machine-readable/machine-executable instructions stored in the machine-readable storage media 904 to receive data from a mobile access point (AP). A mobile AP may be a vehicle, computer, smartphone, or any mobile device that may be transported and includes wireless broadband coverage/communications to receive data from other vehicles and transmit data to an external data storage system or centralized database, such as, for example, a cloud database system. Prior to receiving data from the mobile AP, a signal may be transmitted across a plurality of communication networks to the mobile AP. The signal may include information indicating that a sender vehicle has data to transmit and offload from its data storage. One or more mobile APs surrounding the sender vehicle may receive the transmitted signal.

The sender vehicle may include, for example, an automobile, truck, motorcycle, bicycle, scooter, moped, recreational vehicle and other like on- or off-road vehicles. The sender vehicle may include, for example, an autonomous, semi-autonomous and manual operation. The sender vehicle and a plurality of mobile APs may each include a (wireless or wired) communication system to communicate with each other, other vehicles, infrastructure elements, cloud components and other external entities using any of a number of communication protocols including, for example, V2V (vehicle-to-vehicle), V2I (vehicle-to-infrastructure) and V2X (vehicle-to-everything) protocols. Such a wireless communication system may allow the sender vehicle and each of the mobile APs to receive information from other objects and vehicles including, for example, data storage capacity information, communication signal information, map data, data regarding infrastructure elements, navigation data, data regarding operation and intention of surrounding vehicles, and so on. A wireless communication system may allow the sender vehicle and each of a plurality of mobile APs to receive updates to data that can be used to execute one or more vehicle control modes, and vehicle control algorithms. Wireless communication system may also allow the sender vehicle and one or more mobile APs to transmit information to other objects and receive information from other objects (such as other vehicles, user devices, or infrastructure).

The sender vehicle may receive information from any number of mobile APs that are surrounding the sender vehicle. The sender vehicle may receive information from a mobile AP when the mobile AP is within a perimeter or distance from the sender vehicle. The perimeter or distance from the sender vehicle that a mobile AP may be within may be preset or adjusted according to one or more contributing factors, including the time of day, infrastructure of the sender vehicle, communication settings of the sender vehicle, navigation trajectory of the sender vehicle, etc. The information of the mobile AP may include metadata on the mobile AP. The metadata of the mobile AP may include data storage capacity, including the total data storage capacity, the amount of available data storage capacity, the amount of data storage capacity reserved for incoming data, etc. The information, such as metadata, of the mobile AP may also include attributes and components of the mobile AP, including, for example, communication settings, identification information, navigation information, operating systems, and resources (e.g., CPU, memory, networking, applications, etc.). In this way, the sender vehicle may determine whether the mobile AP has a sufficient amount of available data storage capacity to receive and retain the data to be transmitted from the sender vehicle.

At step 908, the hardware processor(s) 902 may execute machine-readable/machine-executable instructions stored in the machine-readable storage media 904 to determine available storage capacity of the mobile AP to receive sender data of a sender vehicle. The sender vehicle may be a vehicle that may include wireless broadband coverage/communications to receive data from and transmit data to a mobile AP. The information of the mobile AP received by the sender vehicle may include metadata on the mobile AP's data storage capacity, including the total data storage capacity, the amount of available data storage capacity, the amount of data storage capacity reserved for incoming data, etc. The sender vehicle may use the information on the mobile AP to determine whether the mobile AP has a sufficient amount of available data storage capacity to receive and retain the data to be transmitted from the ego vehicle.

At step 910, the hardware processor(s) 902 may execute machine-readable/machine-executable instructions stored in the machine-readable storage media 904 to evaluate the mobile AP against other available mobile APs with sufficient available storage capacity, in response to determining the mobile AP includes a sufficient amount of available storage capacity to receive the sender data. If the ego vehicle determines that the mobile AP does not have a sufficient amount of available data storage capacity to receive and retain the data to be transmitted, the sender vehicle may reject the establishment of a communication link with the mobile AP. If a communication link is already established between the sender vehicle and the mobile AP, then the sender vehicle may disconnect the communication link with the mobile AP upon a determination that the mobile AP has an insufficient amount of available data storage capacity to receive and retain the data of the sender vehicle to be transmitted. The sender vehicle may place any mobile AP that is determined to have insufficient data storage capacity on a list, such as a blacklist, of unavailable mobile APs for the sender vehicle. Mobile APs may remain on the blacklist for a particular period of time to allow the mobile APs to free up their data storage capacity. The particular period of time may be preset or adjusted based on one or more contributing factors, including the time of day, infrastructure of the sender vehicle, communication settings of the sender vehicle, navigation trajectory of the sender vehicle, etc. Each sender vehicle may have its own blacklist of mobile APs with insufficient data storage capacity. All mobile APs listed on the blacklist of the sender vehicle may be removed from the blacklist when the sender vehicle transmits its data to a mobile AP.

Alternatively, if the sender vehicle determines that the mobile AP does have a sufficient amount of available data storage capacity to receive and retain the data to be transmitted, the sender vehicle may tag the mobile AP as an available mobile AP. The sender vehicle may determine that a plurality of mobile APs each have a sufficient amount of available data storage capacity to receive and retain the data to be transmitted. Each mobile AP that is determined to have a sufficient amount of available data storage capacity may be tagged as an available mobile AP. When more than one mobile AP is tagged as an available mobile AP, the sender vehicle may evaluate each of the available mobile APs to determine a designated mobile AP to establish a communication link with.

Evaluating a plurality of available mobile APs, each with a sufficient available data storage capacity, may include determining and comparing the communication signal strength of each available mobile AP with respect to the sender vehicle. The communication signal strength of a mobile AP may be based on the communication settings and navigation information of the respective mobile AP with respect to the sender vehicle. The communication settings may include the communication interface, protocols, components, and other communication capabilities and features of the mobile AP. The communication settings of a mobile AP may further include an application (e.g., Wi-Fi setup application, data transfer application, wireless connection application, etc.) to support transmitting and transferring data between the sender vehicle and the mobile AP. Such an application may include protocols, components and other features that may quickly, efficiently, and securely establish a communication link and support data transfer between the mobile AP and the sender vehicle. Using the application to establish a communication link may increase the likelihood of successfully transmitting data from the sender vehicle to the mobile AP with little to no interferences because of poor reception, increased latency, and noise disturbances.

In one example, upon evaluating each of the plurality of mobile APs with sufficient available data storage capacity, the sender vehicle may select a mobile AP with an application for data transfer, such as, for example, a data sending application, a Wi-Fi setup application, a wireless connection application, etc. The sender vehicle may select a mobile AP with an application for data transfer that is active and available to support data to be transmitted between the sender vehicle and the mobile AP. If it is determined that a mobile AP with sufficient available data storage capacity either does not include an application for data transfer or includes an inactive and unavailable application for data transfer, the sender vehicle may reject the establishment of a communication link with the mobile AP. If a communication link is already established between the sender vehicle and the mobile AP, then the sender vehicle may disconnect the communication link with the mobile AP upon a determination that the mobile AP does not include an application for data transfer or the mobile AP does include an application for data transfer that is inactive and unavailable to support transmitting data.

A sender vehicle may place any mobile AP that is determined to either not include an application for data transfer or include an application for data transfer that is inactive and unavailable to support transmitting data on a list, such as a blacklist, of unavailable mobile APs for the sender vehicle. Mobile APs may remain on a list of unavailable of mobile APs for a particular period of time to allow the mobile APs to obtain an active and available application to support data transfer. The particular period of time may be preset or adjusted based on one or more contributing factors, including the time of day, infrastructure of the sender vehicle, communication settings of the sender vehicle, navigation trajectory of the sender vehicle, etc. Each sender vehicle may have its own list, such as a blacklist, of unavailable mobile APs. All mobile APs listed in a blacklist of a sender vehicle may be removed from the blacklist when the sender vehicle transmits its data to a mobile AP.

The navigation information of a mobile AP may include a current location, direction of movement, speed, travel duration, destination, and trajectory of the mobile AP. Such navigation information may be used to determine if the respective mobile AP may have a similar trajectory to the sender vehicle. Having similar trajectories between the sender vehicle and a mobile AP may allow the sender vehicle and mobile AP to stay in close proximity to one another during their individual travels. The closer the sender vehicle and a mobile AP are, the stronger the communication signal may be between the sender vehicle and the mobile AP. The signal strength may be directly correlated to the strength and stability of a communication link between the sender vehicle and the mobile AP. The strength and stability of the communication link between a mobile AP and the sender vehicle may impact the speed and efficiency in transmitting data, thus increasing the likelihood in successfully transmitting all of the necessary data with little to no interferences due to poor connections.

At step 912, the hardware processor(s) 902 may execute machine-readable/machine-executable instructions stored in the machine-readable storage media 904 to select a designated mobile AP from the plurality of available mobile APs to receive the sender data. Upon evaluating each of the plurality of available mobile APs with sufficient available data storage capacity, the sender vehicle may select a designated mobile AP with the strongest communication signal strength to establish a communication link with. In this way, the sender vehicle may increase its likelihood in successfully transmitting its data to the designated mobile AP with little to no interferences due to poor reception, bad communication connection, increased latency, and noise disturbances.

At step 914, the hardware processor(s) 902 may execute machine-readable/machine-executable instructions stored in the machine-readable storage media 904 to send the sender data of the sender vehicle to the designated mobile AP. Upon selecting a designated mobile AP, the sender vehicle may establish a communication link with the designated mobile AP. The sender vehicle may transmit data to the designated mobile AP using the established communication link. The designated mobile AP may store the data of the sender vehicle in its data storage upon receiving it from the sender vehicle. By transmitting data to the designated mobile AP, the sender vehicle may free up its data storage capacity to enable the collection and storage of additional data. The designated mobile AP may have a larger data storage capacity than the sender vehicle store greater amounts of data before reaching its maximum capacity.

To contribute to maintaining or increasing the signal strength and overall communication link between the sender vehicle and the designated mobile AP while the sender vehicle is transmitting its data to the designated mobile AP, the sender vehicle may adjust its navigational settings, including its speed and trajectory, to the navigational settings of the designated mobile AP. The sender vehicle may obtain the navigational settings of the designated mobile AP from the information received from the designated mobile AP when evaluating the available data storage capacity of the designated mobile AP. By adjusting the speed and trajectory of the sender vehicle to match, or be similar to, the speed and trajectory of the designated mobile AP, the speed, efficiency, and success rate of the data transfer between the sender vehicle and the designated mobile AP may increase.

When the designated mobile AP has received all of the transmitted data from the sender vehicle, the communication link between the sender vehicle and the designated mobile AP may be disconnected. The designated mobile AP and the sender vehicle may each continue traveling to their respective destinations. The sender vehicle may continue to collect, obtain and store data and may determine a next mobile AP to establish a communication link with and transmit data to when the sender vehicle's data storage capacity reaches a certain threshold. The threshold may be preset or adjusted according to one or more contributing factors, including the infrastructure of the vehicle. The designated mobile AP may establish connections with, and receive and retain additional data from other vehicles during the course of its travels. The designated mobile AP may obtain additional data until its data storage capacity reaches its limit, or until it reaches a location where it may connect to a base station to transmit all of the data to an external data storage system, such as a cloud database. Once the designated mobile AP has offloaded and transmitted its data to an external data storage system, the designated mobile AP may continue to establish connections with, and receive and retain additional data from other vehicles.

The present disclosure allows an ego vehicle to offload its data while mobile and irrespective of its location, freeing up the ego vehicle's data storage in a convenient manner. Having the means to more easily and accessibly offload data from its data storage, an ego vehicle may efficiently and consistently collect data with minimum to no interferences caused by poor reception, bad communication connectivity, increased latency, noise disturbances, and a need to directly connect to an external communication connection to transmit its data directly to an external database. The present disclosure also describes how an ego vehicle, or data transfer system, may obtain information of and determine the available data storage capacities of a plurality of mobile APs before having to establish a communication connection. This may increase the efficiency in setting up and establishing communication connections by ensuring that an ego vehicle determines a suitable mobile AP to send data to before expensing the resources and time to establish a communication connection. This may further decrease, or potentially eliminate, the establishment of unnecessary communication connections between devices, which may waste resources and money.

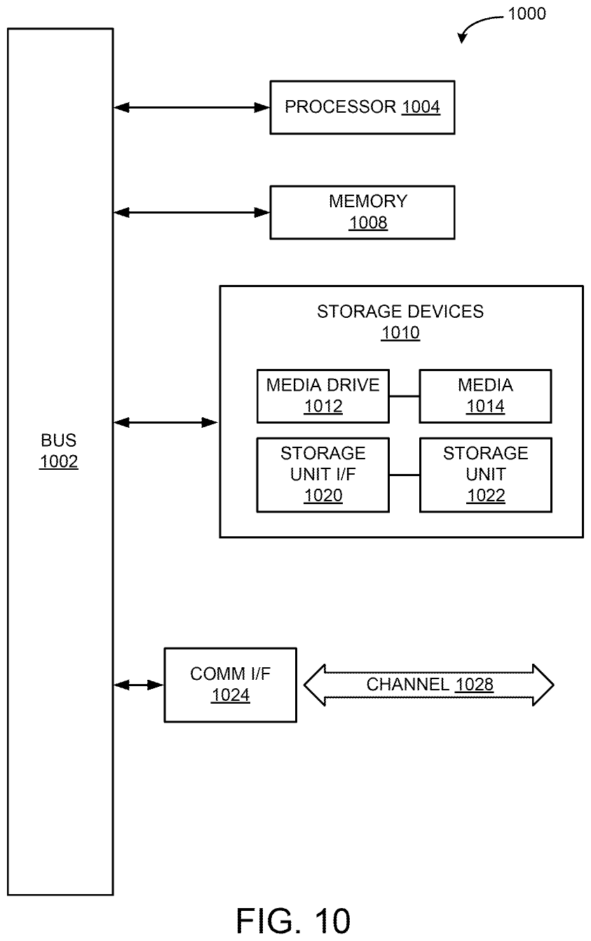

As used herein, the terms circuit, system, and component might describe a given unit of functionality that can be performed in accordance with one or more applications of the present application. As used herein, a component might be implemented utilizing any form of hardware, software, or a combination thereof. For example, one or more processors, controllers, ASICS, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 10. Various applications are described in terms of this example-computing component 1000. After reading this description, it will become apparent to a person skilled in the relevant art how to implement the application using other computing components or architectures.

Referring now to FIG. 10, computing component 1000 may represent, for example, computing or processing capabilities found within a vehicle (e.g., vehicle 150, vehicle 200, vehicle 410, vehicle 412, vehicle 414, vehicle 416, vehicle 510, vehicle 512, vehicle 514), user device, self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1000 might also represent computing capabilities embedded within or otherwise available to a given device. For example, a computing component might be found in other electronic devices such as, for example, portable computing devices, and other electronic devices that might include some form of processing capability. In another example, a computing component might be found in components making up vehicle 150, vehicle 200, data transfer circuit 310, decision and control circuit 303, computing system 100, computing system 210, ECU 225, vehicle 412, vehicle 510, etc.

Computing component 1000 might include, for example, one or more processors, controllers, control components, or other processing devices. This can include a processor, and any one or more of the components making up vehicle 150 of FIG. 1, vehicle 200 of FIG. 2, computing system 210 of FIG. 2, data transfer system 300 of FIG. 3, vehicles 410, 412, 414, and 416 of FIG. 4, and vehicles 510, 512, and 514 of FIG. 5. Processor 1004 might be implemented using a general-purpose or special-purpose processing engine such as, for example, a microprocessor, controller, or other control logic. The processor 1004 might be specifically configured to execute one or more instructions for execution of logic of one or more circuits described herein, such as data transfer circuit 310, decision and control circuit 303, and logic for control systems 240. Processor 1004 may be configured to execute one or more instructions for performing one or more methods, such as the processes described in FIGS. 6, 7, and 8, and the method described in FIG. 9.

Processor 1004 may be connected to a bus 1002. However, any communication medium can be used to facilitate interaction with other components of computing component 1000 or to communicate externally. In applications, processor 1004 may fetch, decode, and execute one or more instructions to control processes and operations for enabling vehicle servicing as described herein. For example, instructions can correspond to steps for performing one or more steps of the processes described in FIGS. 6, 7, and 8, and the method described in FIG. 9.

Computing component 1000 might also include one or more memory components, simply referred to herein as main memory 1008. For example, random access memory (RAM) or other dynamic memory, might be used for storing information and instructions to be fetched, decoded, and executed by processor 1004. Such instructions may include one or more instructions for execution of one or more logical circuits described herein. Instructions can include instructions 208 of FIG. 2, and instructions 309 of FIG. 3 as described herein, for example. Main memory 1008 might also be used for storing temporary variables or other intermediate information during execution of instructions to be fetched, decoded, and executed by processor 1004. Computing component 1000 might likewise include a read only memory (“ROM”) or other static storage device coupled to bus 1002 for storing static information and instructions for processor 1004.

The computing component 1000 might also include one or more various forms of information storage mechanism 1010, which might include, for example, a media drive 1012 and a storage unit interface 1020. The media drive 1012 might include a drive or other mechanism to support fixed or removable storage media 1014. For example, a hard disk drive, a solid-state drive, a magnetic tape drive, an optical drive, a compact disc (CD) or digital video disc (DVD) drive (R or RW), or other removable or fixed media drive might be provided. Storage media 1014 might include, for example, a hard disk, an integrated circuit assembly, magnetic tape, cartridge, optical disk, a CD or DVD. Storage media 1014 may be any other fixed or removable medium that is read by, written to or accessed by media drive 1012. As these examples illustrate, the storage media 1014 can include a computer usable storage medium having stored therein computer software or data.

In alternative applications, information storage mechanism 1010 might include other similar instrumentalities for allowing computer programs or other instructions or data to be loaded into computing component 1000. Such instrumentalities might include, for example, a fixed or removable storage unit 1022 and an interface 1020. Examples of such storage unit 1022 and interface 1020 can include a program cartridge and cartridge interface, a removable memory (for example, a flash memory or other removable memory component) and memory slot. Other examples may include a PCMCIA slot and card, and other fixed or removable storage units 1022 and interfaces 1020 that allow software and data to be transferred from storage unit 1022 to computing component 1000.

Computing component 1000 might also include a communications interface 1024. Communications interface 1024 might be used to allow software and data to be transferred between computing component 1000 and external devices. Examples of communications interface 1024 might include a modem or softmodem, a network interface (such as Ethernet, network interface card, IEEE 802.XX or other interface). Other examples include a communication port (such as for example, a USB port, IR port, RS232 port Bluetooth® interface, or other port), or other communications interface. Software/data transferred via communications interface 1024 may be carried on signals, which can be electronic, electromagnetic (which includes optical) or other signals capable of being exchanged by a given communications interface 1024. These signals might be provided to communications interface 1024 via a channel 1028. Channel 1028 might carry signals and might be implemented using a wired or wireless communication medium. Some examples of a channel might include a phone line, a cellular link, an RF link, an optical link, a network interface, a local or wide area network, Controller Area Network (CAN), and other wired or wireless communications channels.

In this document, the terms “computer program medium” and “computer usable medium” are used to generally refer to transitory or non-transitory media. Such media may be, e.g., memory 1008, storage unit 1022, media 1014, and channel 1028. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1000 to perform features or functions of the present application as discussed herein.

As described herein, vehicles can be flying, partially submersible, submersible, boats, roadway, off-road, passenger, truck, trolley, train, drones, motorcycle, bicycle, or other vehicles. As used herein, vehicles can be any form of powered or unpowered transport.

The term “operably connected,” “coupled”, or “coupled to”, as used throughout this description, can include direct or indirect connections, including connections without direct physical contact, electrical connections, optical connections, and so on.

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, or C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof. While various applications of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various applications be implemented to perform the recited functionality in the same order, and with each of the steps shown, unless the context dictates otherwise.

Although the disclosed technology is described above in terms of various exemplary applications and implementations, it should be understood that the various features, aspects and functionality described in one or more of the individual applications are not limited in their applicability to the particular application with which they are described. Instead, they can be applied, alone or in various combinations, to one or more other applications of the disclosed technology, whether or not such applications are described and whether or not such features are presented as being a part of a described application. Thus, the breadth and scope of the technology disclosed herein should not be limited by any of the above-described exemplary applications.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various applications set forth herein are described in terms of exemplary block diagrams, flow charts and other illustrations. As will become apparent to one of ordinary skill in the art after reading this document, the illustrated applications and their various alternatives can be implemented without confinement to the illustrated examples. For example, block diagrams and their accompanying description should not be construed as mandating a particular architecture or configuration.

What is claimed is:

1. A computer implemented method comprising:
receiving information from a first mobile access point (AP);
determining, based on the information, available storage capacity of the first mobile AP to receive sender data of a sender vehicle;
in response to determining the available storage capacity of the first mobile AP is an amount sufficient to receive the sender data, evaluating the first mobile AP against other available mobile APs with sufficient available storage capacity to receive the sender data of the sender vehicle;
selecting, based on the evaluation, a mobile AP from the first mobile AP and the other available mobile APs with sufficient available storage capacity to be a designated mobile AP to receive the sender data; and
sending the sender data of the sender vehicle to the designated mobile AP.

2. The method of claim 1, further comprising, prior to receiving information from the first mobile AP, sending a signal for transmitting the sender data to the first mobile AP.

3. The method of claim 1, wherein the first mobile AP is part of a vehicle.

4. The method of claim 1, wherein the information received from the first mobile AP comprises data storage capacity, communication settings, identification information, and navigation information.

5. The method of claim 1, wherein the first mobile AP and the other available mobile APs with sufficient available storage capacity are within a threshold distance from the sender vehicle.

6. The method of claim 4, wherein the evaluating the first mobile AP against the other available mobile APs with sufficient available storage capacity comprises:
determining a first signal strength of the first mobile AP, wherein the first signal strength is based on the communication settings and the navigation information of the first mobile AP with respect to the sender vehicle; and
comparing the first signal strength of the first mobile AP with signal strengths of the other available mobile APs.

7. The method of claim 6, wherein the navigation information comprises a current location, direction of movement, speed, travel duration, and destination of the first mobile AP.

8. The method of claim 6, wherein the designated mobile AP has a highest signal strength with the sender vehicle from the first mobile AP and the other available mobile APs.

9. The method of claim 1, wherein the designated mobile AP is chosen, in part, based on its trajectory as compared to a trajectory of the sender vehicle.

10. The method of claim 1, wherein the designated mobile AP is chosen, in part, based on the designated mobile AP comprising an application ready to initiate data transfer.

11. The method of claim 1, further comprising, in response to determining the available storage capacity of the first mobile AP is an amount insufficient to receive the sender data, storing the mobile AP on a list of unavailable mobile APs for a determined time period.

12. The method of claim 1, further comprising, while sending the sender data of the sender vehicle to the designated mobile AP, adjusting a speed and trajectory of the sender vehicle according to navigation information of the designated mobile AP.

13. A vehicle control system, comprising:
a processor; and
a memory coupled to the processor to store instructions, which when executed by the processor, cause the processor to perform operations, the operations comprising:
receiving information from a first mobile access point (AP);
determining, based on the information, available storage capacity of the first mobile AP to receive sender data of a sender vehicle;
in response to determining the available storage capacity of the first mobile AP is an amount sufficient to receive the sender data, evaluating the first mobile AP against other available mobile APs with sufficient available storage capacity to receive the sender data of the sender vehicle;
selecting, based on the evaluation, a mobile AP from the first mobile AP and the other available mobile APs with sufficient available storage capacity to be a designated mobile AP to receive the sender data; and
sending the sender data of the sender vehicle to the designated mobile AP.

14. The system of claim 13, wherein the information received from the first mobile AP comprises data storage capacity, communication settings, identification information, and navigation information, and the navigation information comprises a current location, direction of movement, speed, travel duration, and destination of the first mobile AP.

15. The system of claim 14, wherein the evaluating the first mobile AP against the other available mobile APs with sufficient available storage capacity comprises:
determining a first signal strength of the first mobile AP, wherein the first signal strength is based on the communication settings and the navigation information of the first mobile AP with respect to the sender vehicle; and
comparing the first signal strength of the first mobile AP with signal strengths of the other available mobile APs.

16. The system of claim 15, wherein the designated mobile AP has a highest signal strength with the sender vehicle from the first mobile AP and the other available mobile APs.

17. The system of claim 13, wherein the designated mobile AP is chosen, in part, based on its trajectory as compared to a trajectory of the sender vehicle.

18. The system of claim 13, wherein the designated mobile AP is chosen, in part, based on the designated mobile AP comprising an application ready to initiate data transfer.

19. The system of claim 13, wherein the operations further comprise: while sending the sender data of the sender vehicle to the designated mobile AP, adjusting a speed and trajectory of the sender vehicle according to navigation information of the designated mobile AP.

20. A non-transitory machine-readable medium having instructions stored therein, which when executed by a processor, cause the processor to perform operations, the operations comprising:
receiving information from a first mobile access point (AP);
determining, based on the information, available storage capacity of the first mobile AP to receive sender data of a sender vehicle;
in response to determining the available storage capacity of the first mobile AP is an amount sufficient to receive the sender data, evaluating the first mobile AP against other available mobile APs with sufficient available storage capacity to receive the sender data of the sender vehicle;
selecting, based on the evaluation, a mobile AP from the first mobile AP and the other available mobile APs with sufficient available storage capacity to be a designated mobile AP to receive the sender data; and
sending the sender data of the sender vehicle to the designated mobile AP.
